(19) United States
(12) Patent Application Publication
(10) Pub. No.: US 2025/0084194 A1
(43) Pub. Date: Mar. 13, 2025

(54) SILANES FOR ADDRESSING VISCOSITY INSTABILITY IN SILANE TERMINATED SSBR

(71) Applicant: MOMENTIVE PERFORMANCE MATERIALS INC., Niskayuna, NY (US)

(72) Inventors: Lesley HWANG, Chappaqua, NY (US); Nancy Ann WINCHESTER, Charlotte, NC (US); Matthew J. PINNOW, Niskayuna, NY (US); Yogesh CHANDRASEKARAN, Bangalore (IN); Lifeng CHEN, Charlotte, NC (US); Kaustubh A. JOSHI, Bengaluru, Karnataka (IN)

(21) Appl. No.: 18/882,476

(22) Filed: Sep. 11, 2024

Related U.S. Application Data
(60) Provisional application No. 63/581,954, filed on Sep. 11, 2023.

(51) Int. Cl. C08F 136/14; B60C 1/00; C07F 7/18

(52) U.S. Cl. CPC C08F 136/14; B60C 1/0016; B60C 1/0025; C07F 7/188

(57) ABSTRACT

The present disclosure relates to silane coupling agents, silane functional polymers, a method of making silane coupling agents, and the use of silane coupling agents in a method of making silane functional polymers. The present disclosure further relates to a composition comprising one or more silane functional polymers, as well as a number of usage compositions.

### FIELD OF THE DISCLOSURE

The present disclosure relates to silane coupling agents, silane functional polymers, a method of making silane coupling agents, and the use of silane coupling agents in a method of making silane functional polymers. The present disclosure further relates to a composition comprising one or more silane functional polymers, as well as a number of usage compositions.

### BACKGROUND

The addition of silane functionality to solution styrene butadiene rubber (SSBR) polymers is desired by polymer manufacturers and tire compounders because it can be used to produce rubber compounds with improved properties (e.g., improved wear, improved rolling resistance, and improved handling). Traditionally, the addition of aminosilanes, thiosilanes, or oxysilanes to SSBR polymers is problematic because the N—H, S—H, and O—H functionality poisons the living polymer and results in no silane functionality being added to SSBR polymers.

To overcome this technical deficiency using standard silane compounds, tertiary aminosilanes (U.S. 2021/0130591), which have no N—H functionality, and protected aminosilanes (JP 11349632) have been tested. However, tertiary silane compounds are not preferred, due to the lack of N—H, S—H, and O—H functionality. The presence of N—H, S—H, O—H functionality is desired because it enables hydrogen bonding to the silica in rubber compounds, which improves the interaction between polymer and silica and leads to improved rubber properties.

SSBRs which are functionalized with silane terminal groups are used as polymers to prepare rubber compounds because they provide rolling resistance and wear resistance benefits to those compounds. One drawback of having a silane terminal group is that the polymer often suffers from viscosity instability, specifically, that the viscosity of the polymer increases upon storage. This is undesirable because it can cause difficulties when used in processing applications for rubber compounds. One method used to measure the change in viscosity of both natural and synthetic rubbers due to functionalization with silane terminal groups is the Mooney viscosity test.

It is generally accepted that the viscosity increase is due to the formation of Si—O—Si bonds resulting from the condensation over time of silanol or alkoxysilane groups on the silane terminal groups. The Si—O—Si bond formation results in links between polymer chains, resulting in longer chains, and thus increased viscosity.

The use of a protecting group on a silane compound has also shown technical challenges associated with the stability of the protecting group (U.S. Pat. No. 10,457,697). Therefore, there is a need for improved silane compounds and methods to prepare such silane compounds to overcome the technical challenges of conventional silane compounds and methods to prepare them.

### BRIEF SUMMARY OF THE DISCLOSURE

In some aspects, the present disclosure provides a silane compound of Formula (I):

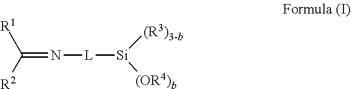

wherein
each R¹ and R² independently is hydrogen; an optionally substituted alkyl group having from 1 to 20 carbon atoms, where the optional substituent is one or more heteroatom; an optionally substituted alkenyl group having from 2 to 20 carbon atoms, where the optional substituents is one or more heteroatom; an optionally substituted cycloalkyl group having from 3 to 10 carbon atoms, where the optional substituent is one or more heteroatom; an optionally substituted aryl group having from 6 to 12 carbon atoms, where the optional substituent is one or more heteroatom; or an optionally substituted aralkyl group having from 7 to 16 carbon atoms, where the optional substituent is one or more heteroatom;
L is an optionally substituted alkylene group having from 1 to 20 carbon atoms, where the optional substituent is one or more heteroatom; an optionally substituted alkenylene group having from 2 to 20 carbon atoms, where the optional substituent is one or more heteroatom; an optionally substituted cycloalkylene group having from 3 to 10 carbon atoms, where the optional substituent is one or more heteroatom; an optionally substituted arylene group having from 6 to 12 carbon atoms, where the optional substituent is one or more heteroatom; or an optionally substituted aralkylene group having from 7 to 16 carbon atoms, where the optional substituent is one or more heteroatom;
R³ is an optionally substituted alkyl group having from 1 to 20 carbon atoms, where the optional substituent is one or more heteroatom; an optionally substituted alkenyl group having from 2 to 20 carbon atoms, where the optional substituent is one or more heteroatom; an optionally substituted cycloalkyl group having from 3 to 10 carbon atoms, where the optional substituent is one or more heteroatom; an optionally substituted aryl group having from 6 to 12 carbon atoms, where the optional substituent is one or more heteroatom; or an optionally substituted aralkyl group having from 7 to 16 carbon atoms, where the optional substituent is one or more heteroatom;
each R⁴ independently is an optionally substituted alkyl group having from 6 to 30 carbon atoms, where the optional substituent is one or more heteroatom; an optionally substituted alkenyl group having from 6 to 30 carbon atoms, where the optional substituent is one or more heteroatom; an optionally substituted alkynyl group having from 6 to 30 carbon atoms, where the optional substituent is one or more heteroatom; an optionally substituted cycloalkyl group having from 3 to 10 carbon atoms, where the optional substituent is one or more heteroatom; an optionally substituted aryl group having from 6 to 12 carbon atoms, where the optional substituent is one or more heteroatom; an optionally substituted aralkyl group having from 7 to 20 carbon atoms, where the optional substituent is one or more heteroatom; or an optionally substituted cyclic silane; or
R⁴ is R²³, where each R²³ independently is an optionally substituted straight chain or branched chain alkyl group, having from 1 to 10 carbon atoms, where two R²³ combine with each other to form a ring together with the —O—Si—O— atoms to which they are bonded, and where the optional substituent is one or more heteroatom, and wherein the two R²³ can be the same or different; or
each R⁴ independently is a group represented by —(R⁵—O)ₘ—R⁶, where each R⁵ is the same as or different from each other and each represents a branched or unbranched C₁-C₃₀ divalent hydrocarbon group; R⁶ represents a branched or unbranched C₁-C₃₀ alkyl group, a branched or unbranched C₂-C₃₀ alkenyl group, a C₆-C₃₀ aryl group, or a C₇-C₃₀ aralkyl group; and m is an integer of 1 to 30; and
b is 2 or 3.

In some aspects, the present disclosure provides a polymer represented by Formula (II)

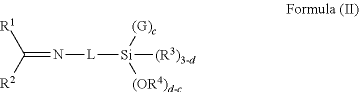

wherein
each R¹ and R² independently is hydrogen; an optionally substituted alkyl group having from 1 to 20 carbon atoms, where the optional substituent is one or more heteroatom; an optionally substituted alkenyl group having from 2 to 20 carbon atoms, where the optional substituents is one or more heteroatom; an optionally substituted cycloalkyl group having from 3 to 10 carbon atoms, where the optional substituent is one or more heteroatom; an optionally substituted aryl group having from 6 to 12 carbon atoms, where the optional substituent is one or more heteroatom; or an optionally substituted aralkyl group having from 7 to 16 carbon atoms, where the optional substituent is one or more heteroatom;
L is an optionally substituted alkylene group having from 1 to 20 carbon atoms, where the optional substituent is one or more heteroatom; an optionally substituted alkenylene group having from 2 to 20 carbon atoms, where the optional substituent is one or more heteroatom; an optionally substituted cycloalkylene group having from 3 to 10 carbon atoms, where the optional substituent is one or more heteroatom; an optionally substituted arylene group having from 6 to 12 carbon atoms, where the optional substituent is one or more heteroatom; or an optionally substituted aralkylene group having from 7 to 16 carbon atoms, where the optional substituent is one or more heteroatom;
R³ is an optionally substituted alkyl group having from 1 to 20 carbon atoms, where the optional substituent is one or more heteroatom; an optionally substituted alkenyl group having from 2 to 20 carbon atoms, where the optional substituent is one or more heteroatom; an optionally substituted cycloalkyl group having from 3 to 10 carbon atoms, where the optional substituent is one or more heteroatom; an optionally substituted aryl group having from 6 to 12 carbon atoms, where the optional substituent is one or more heteroatom; or an optionally substituted aralkyl group having from 7 to 16 carbon atoms, where the optional substituent is one or more heteroatom;
each R⁴ independently is an optionally substituted alkyl group having from 6 to 30 carbon atoms, where the optional substituent is one or more heteroatom; an optionally substituted alkenyl group having from 6 to 30 carbon atoms, where the optional substituent is one or more heteroatom; an optionally substituted alkynyl group having from 6 to 30 carbon atoms, where the optional substituent is one or more heteroatom; an optionally substituted cycloalkyl group having from 3 to 10 carbon atoms, where the optional substituent is one or more heteroatom; an optionally substituted aryl group having from 6 to 12 carbon atoms, where the optional substituent is one or more heteroatom; an optionally substituted aralkyl group having from 7 to 20 carbon atoms, where the optional substituent is one or more heteroatom; or an optionally substituted cyclic silane; or
R⁴ is R²³, where each R²³ independently is an optionally substituted straight chain or branched chain alkyl group, having from 1 to 10 carbon atoms, where two R²³ combine with each other to form a ring together with the —O—Si—O— atoms to which they are bonded, and where the optional substituent is one or more heteroatom, and wherein the two R²³ can be the same or different; or
each R⁴ independently is a group represented by —(R⁵—O)ₘ—R⁶, where each R⁵ is the same as or different from each other and each represents a branched or unbranched C₁-C₃₀ divalent hydrocarbon group; R⁶ represents a branched or unbranched C₁-C₃₀ alkyl group, a branched or unbranched C₂-C₃₀ alkenyl group, a C₆-C₃₀ aryl group, or a C₇-C₃₀ aralkyl group; and m is an integer of 1 to 30;

each G is independently a polymer fragment having a backbone of carbon atoms covalently bonded together by C—C single bond, C═C double bond, or a combination of C—C single bonds and C═C double bonds;
c is 1 or 2, with the proviso that c is equal to or less than d; and
dis 1, 2, or 3.

In some aspects, the present disclosure provides a polymer represented by Formula (IV)

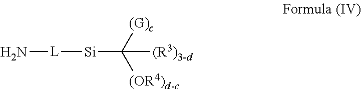

wherein
L is an optionally substituted alkylene group having from 1 to 20 carbon atoms, where the optional substituent is one or more heteroatom; an optionally substituted alkenylene group having from 2 to 20 carbon atoms, where the optional substituent is one or more heteroatom; an optionally substituted cycloalkylene group having from 3 to 10 carbon atoms, where the optional substituent is one or more heteroatom; an optionally substituted arylene group having from 6 to 12 carbon atoms, where the optional substituent is one or more heteroatom; or an optionally substituted aralkylene group having from 7 to 16 carbon atoms, where the optional substituent is one or more heteroatom;
R³ is an optionally substituted alkyl group having from 1 to 20 carbon atoms, where the optional substituent is one or more heteroatom; an optionally substituted alkenyl group having from 2 to 20 carbon atoms, where the optional substituent is one or more heteroatom; an optionally substituted cycloalkyl group having from 3 to 10 carbon atoms, where the optional substituent is one or more heteroatom; an optionally substituted aryl group having from 6 to 12 carbon atoms, where the optional substituent is one or more heteroatom; or an optionally substituted aralkyl group having from 7 to 16 carbon atoms, where the optional substituent is one or more heteroatom;
each R⁴ independently is an optionally substituted alkyl group having from 6 to 30 carbon atoms, where the optional substituent is one or more heteroatom; an optionally substituted alkenyl group having from 6 to 30 carbon atoms, where the optional substituent is one or more heteroatom; an optionally substituted alkynyl group having from 6 to 30 carbon atoms, where the optional substituent is one or more heteroatom; an optionally substituted cycloalkyl group having from 3 to 10 carbon atoms, where the optional substituent is one or more heteroatom; an optionally substituted aryl group having from 6 to 12 carbon atoms, where the optional substituent is one or more heteroatom; an optionally substituted aralkyl group having from 7 to 20 carbon atoms, where the optional substituent is one or more heteroatom; or an optionally substituted cyclic silane; or
R⁴ is R²³, where each R²³ independently is an optionally substituted straight chain or branched chain alkyl group, having from 1 to 10 carbon atoms, where two R²³ combine with each other to form a ring together with the —O—Si—O— atoms to which they are bonded, and where the optional substituent is one or more heteroatom, and wherein the two R²³ can be the same or different; or
each R⁴ independently is a group represented by —(R⁵—O)ₘ—R⁶, where each R⁵ is the same as or different from each other and each represents a branched or unbranched C₁-C₃₀ divalent hydrocarbon group; R⁶ represents a branched or unbranched C₁-C₃₀ alkyl group, a branched or unbranched C₂-C₃₀ alkenyl group, a C₆-C₃₀ aryl group, or a C₇-C₃₀ aralkyl group; and m is an integer of 1 to 30;
c is 1 or 2, with the proviso that c is equal to or less than d;
d is 2 or 3; and
each G is independently a polymer fragment having a backbone of carbon atoms covalently bonded together by C—C single bond, C═C double bond, or a combination of C—C single bonds and C═C double bonds.

### BRIEF DESCRIPTION OF THE FIGURE

FIG. 1 is a pictorial representation of a method used to prepare the functionalized SSBRs of the present disclosure. The anionic polymerization initiated using n-butyl lithium is very sensitive to moisture and thus, precautions were necessary to prevent the initiator from being quenched.

### DETAILED DESCRIPTION

### I. Definitions

As used above, and throughout the description, the following terms, unless otherwise indicated, shall be understood to have the following meanings.

Unless stated otherwise, the terms “a” and “an” and “the” and similar references used in the context of describing a particular aspect of the application (especially in the context of claims) can be construed to cover both the singular and the plural. The recitation of ranges of values herein is merely intended to serve as a shorthand method of referring individually to each separate value falling within the range. Unless otherwise indicated herein, each individual value is incorporated into the specification as if it were individually recited herein.

Furthermore, “and/or”, where used herein, is to be taken as specific disclosure of each of the two specified features or components with or without the other. Thus, the term “and/or” as used in a phrase such as “A and/or B” herein is intended to include “A and B,” “A or B,” “A” (alone), and “B” (alone). Likewise, the term “and/or” as used in a phrase such as “A, B, and/or C” is intended to encompass each of the following aspects: A, B, and C; A, B, or C; A or C; A or B; B or C; A and C; A and B; B and C; A (alone); B (alone); and C (alone).

It is understood that wherever aspects are described herein with the language “comprising,” otherwise analogous aspects described in terms of “consisting of” and/or “consisting essentially of” are also provided.

The term “polymer” means a substance, chemical compound or mixture of compounds, that has a molecular structure consisting chiefly or entirely of a large number of similar units (e.g., monomer units) bonded together.

The term “about” encompasses the range of experimental error that occurs in any measurement.

The expression “coupling agent” means an agent capable of establishing an effective chemical and/or physical bond between a diene based polymer and a filler or means an agent capable of establishing an effective chemical or physical bond between two diene based polymers. Effective coupling agents have functional groups capable of bonding physically and/or chemically with filler or a second diene based polymer, as for example, between a silanol group of the coupling agent and the hydroxyl (OH) surface groups of the filler (e.g., surface silanols in the case of silica), or between a silanol group attached to one diene polymer with the silanol group of another polymer, and, as for example, sulfur atoms which are capable of bonding physically and/or chemically with the diene based polymers as a result of vulcanization (curing).

The term, “hydrocarbon” as used herein refers to any chemical structure containing hydrogen atoms and carbon atoms.

The term “alkyl” means any monovalent, saturated straight chain or branched chain hydrocarbon group; the term “alkenyl” means any monovalent straight chain or branched chain hydrocarbon group containing one or more carbon-carbon double bonds where the site of attachment of the group can be either at a carbon-carbon double bond or elsewhere therein; and, the term “alkynyl” means any monovalent straight chain or branched chain hydrocarbon group containing one or more carbon-carbon triple bonds and, optionally, one or more carbon-carbon double bonds, where the site of attachment of the group can be either at a carbon-carbon triple bond, a carbon-carbon double bond or elsewhere therein.

Representative examples of alkyls include methyl, ethyl, propyl and isobutyl. Examples of alkenyls include vinyl, propenyl, allyl, methallyl, ethylidenyl norbornane, ethylidene norbornyl, ethylidenyl norbornene and ethylidene norbornenyl. Examples of alkynyls include acetylenyl, propargyl and methylacetylenyl.

The term “cycloalkyl” means any monovalent cyclic aliphatic hydrocarbon group; the term “cycloalkenyl” means any monovalent cyclic aliphatic hydrocarbon group containing one or more carbon-carbon double bonds where the site of attachment of the group can be either at a carbon-carbon double bond or elsewhere therein; and, the term “cycloalkynyl” means any monovalent cyclic aliphatic hydrocarbon group containing one or more carbon-carbon triple bonds and, optionally, one or more carbon-carbon double bonds, where the site of attachment of the group can be either at a carbon-carbon triple bond, a carbon-carbon double bond or elsewhere therein.

Representative examples of cycloalkyl include cyclopentyl, cyclobutyl, cyclopentyl, cycloheptyl, cyclooctyl. Examples of cyloalkenyl include cyclopentenyl, cycloheptenyl and cyclooctatrienyl. An example of cycloalkynyl is cycloheptynyl.

The terms “cycloalkyl”, “cycloalkenyl”, and “cycloalkynyl” include bicyclic, tricyclic and higher cyclic structures as well as the aforementioned cyclic structures further substituted with alkyl, alkenyl, and/or alkynyl groups. Representative examples include norbornyl, norbornenyl, ethylnorbornyl, ethylnorbornenyl, cyclohexyl, ethylcyclohexyl, ethylcyclohexenyl, cyclohexylcyclohexyl and cyclododecatrienyl.

The term “aryl” includes any aromatic hydrocarbon from which one hydrogen atom has been removed; “aralkyl” includes any of the aforementioned alkyl groups in which one or more hydrogen atoms have been substituted by the same number of like and/or different aryl (as defined herein) substituents; and “arenyl” includes any of the aforementioned aryl groups in which one or more hydrogen atoms have been substituted by the same number of like and/or different alkyl (as defined herein) substituents. Specific, non-limiting examples of aryl groups include phenyl and naphthalenyl. Specific, non-limiting examples of aralkyl groups include benzyl and phenethyl. Specific, non-limiting examples of arenyl groups include tolyl and xylyl.

The term “alkylene” is a divalent saturated aliphatic radical derived from an alkane by removal of two hydrogen atoms. The term “alkenylene” is a divalent unsaturated aliphatic radical derived from an alkene by removal of four hydrogen atoms.

The term “heteroatom” means any of the Group 13-17 elements except carbon and includes, for example, oxygen, nitrogen, silicon, sulfur, phosphorus, fluorine, chlorine, bromine and iodine.

The term “halo” or “halogen” as used by itself or as part of another group refers to —CI, —F, —Br, or —I. Other than in the working examples or where otherwise indicated, all numbers expressing amounts of materials, reaction conditions, time durations, quantified properties of materials, and so forth, stated in the specification and claims are to be understood as being modified in all instances by the term “about”.

It will be understood that any numerical range recited herein includes all sub-ranges with that range and any combination of the various endpoints of such ranges or sub-ranges.

It will be further understood that any compound, material, or substance which is expressly or implicitly disclosed in the specification and/or recited in a claim as belonging to a group of structurally, compositionally and/or functionally related compounds, materials, or substances includes individual representatives of the group and all combinations thereof.

### II. Silane Compounds

In some aspects, the present disclosure provides a silane compound having Formula (I)

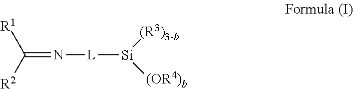

wherein
each R¹ and R² independently is hydrogen; an optionally substituted alkyl group having from 1 to 20 carbon atoms, where the optional substituent is one or more heteroatom; an optionally substituted alkenyl group having from 2 to 20 carbon atoms, where the optional substituents is one or more heteroatom; an optionally substituted cycloalkyl group having from 3 to 10 carbon atoms, where the optional substituent is one or more heteroatom; an optionally substituted aryl group having from 6 to 12 carbon atoms, where the optional substituent is one or more heteroatom; or an optionally substituted aralkyl group having from 7 to 16 carbon atoms, where the optional substituent is one or more heteroatom;
L is an optionally substituted alkylene group having from 1 to 20 carbon atoms, where the optional substituent is one or more heteroatom; an optionally substituted alkenylene group having from 2 to 20 carbon atoms, where the optional substituent is one or more heteroatom; an optionally substituted cycloalkylene group having from 3 to 10 carbon atoms, where the optional substituent is one or more heteroatom; an optionally substituted arylene group having from 6 to 12 carbon atoms, where the optional substituent is one or more heteroatom; or an optionally substituted aralkylene group having from 7 to 16 carbon atoms, where the optional substituent is one or more heteroatom;
R³ is an optionally substituted alkyl group having from 1 to 20 carbon atoms, where the optional substituent is one or more heteroatom; an optionally substituted alkenyl group having from 2 to 20 carbon atoms, where the optional substituent is one or more heteroatom; an optionally substituted cycloalkyl group having from 3 to 10 carbon atoms, where the optional substituent is one or more heteroatom; an optionally substituted aryl group having from 6 to 12 carbon atoms, where the optional substituent is one or more heteroatom; or an optionally substituted aralkyl group having from 7 to 16 carbon atoms, where the optional substituent is one or more heteroatom;
each R⁴ independently is an optionally substituted alkyl group having from 6 to 30 carbon atoms, where the optional substituent is one or more heteroatom; an optionally substituted alkenyl group having from 6 to 30 carbon atoms, where the optional substituent is one or more heteroatom; an optionally substituted alkynyl group having from 6 to 30 carbon atoms, where the optional substituent is one or more heteroatom; an optionally substituted cycloalkyl group having from 3 to 10 carbon atoms, where the optional substituent is one or more heteroatom; an optionally substituted aryl group having from 6 to 12 carbon atoms, where the optional substituent is one or more heteroatom; an optionally substituted aralkyl group having from 7 to 20 carbon atoms, where the optional substituent is one or more heteroatom; or an optionally substituted cyclic silane; or
R⁴ is R²³, where each R²³ independently is an optionally substituted straight chain or branched chain alkyl group, having from 1 to 10 carbon atoms, where two R²³ combine with each other to form a ring together with the —O—Si—O— atoms to which they are bonded, and where the optional substituent is one or more heteroatom, and wherein the two R²³ can be the same or different; or
each R⁴ independently is a group represented by —(R⁵—O)ₘ—R⁶, where each R⁵ is the same as or different from each other and each represents a branched or unbranched C₁-C₃₀ divalent hydrocarbon group: R⁶ represents a branched or unbranched C₁-C₃₀ alkyl group, a branched or unbranched C₂-C₃₀ alkenyl group, a C₆-C₃₀ aryl group, or a C₇₋₃₀ aralkyl group; and m is an integer of 1 to 30; and
b is 2 or 3.

In some aspects, R¹ is an optionally substituted alkyl group having from 1 to 20 carbon atoms, where the optional substituent is one or more heteroatom. In some aspects, the heteroatom is N, O, or S.

In some aspects, R¹ is a C₁-C₂₀ alkyl. In some aspects, R¹ is a C₁-C₁₀ alkyl. In some aspects, R¹ is a C₁-C₅ alkyl. In some aspects, R¹ is a C₄ alkyl. In some aspects, R¹ is —CH₂CH(CH₃)₂.

In some aspects, R² is an optionally substituted alkyl group having from 1 to 20 carbon atoms, where the optional substituent is one or more heteroatom. In some aspects, the heteroatom is N, O, or S.

In some aspects, R² is a C₁-C₂₀ alkyl. In some aspects, R² is a C₁-C₁₀ alkyl. In some aspects, R² is a C₁-C₅ alkyl. In some aspects, R² is methyl.

In some aspects, L is an optionally substituted alkyl group having from 1 to 20 carbon atoms, where the optional substituent is one or more heteroatom. In some aspects, the heteroatom is N, O, or S.

In some aspects, L is a C₁-C₁₂ alkylene. In some aspects, L is a C₁-C₈ alkylene. In some aspects, L is a C₁-C₄ alkylene. In some aspects, L is a C₃ alkylene. In some aspects, L is —CH₂CH₂CH₂—.

In some aspects, R³ is an optionally substituted alkyl group having from 1 to 20 carbon atoms, where the optional substituent is one or more heteroatom. In some aspects, the heteroatom is N, O, or S.

In some aspects, R³ is a C₁-C₂₀ alkyl. In some aspects, R³ is a C₁-C₁₀ alkyl. In some aspects, R³ is a C₁-C₈ alkyl. In some aspects, R³ is methyl.

In some aspects, each R⁴ is different. In some aspects, two R⁴ groups are the same. In some aspects, three R⁴ groups are the same.

In some aspects, at least one R⁴ is an optionally substituted aralkyl group having from 7 to 20 carbon atoms, where the optional substituent is one or more heteroatom. In some aspects, the heteroatom is N, O, or S.

In some aspects, one R⁴ is an optionally substituted aralkyl group having from 7 to 20 carbon atoms, where the optional substituent is one or more heteroatom, and wherein the heteroatom is N, O, or S. In some aspects, two R⁴ are an optionally substituted aralkyl group having from 7 to 20 carbon atoms, where the optional substituent is one or more heteroatom, and wherein the heteroatom is N, O, or S. In some aspects, three R⁴ are an optionally substituted aralkyl group having from 7 to 20 carbon atoms, where the optional substituent is one or more heteroatom, and wherein the heteroatom is N, O, or S.

In some aspects, at least one R⁴ is an optionally substituted aralkyl group having from 7 to 20 carbon atoms.

In some aspects, one R⁴ is an optionally substituted aralkyl group having from 7 to 20 carbon atoms. In some aspects, two R⁴ are an optionally substituted aralkyl group having from 7 to 20 carbon atoms. In some aspects, three R⁴ are an optionally substituted aralkyl group having from 7 to 20 carbon atoms.

In some aspects, two R⁴ are a C₇-C₂₀ aralkyl. In some aspects, two R⁴ are

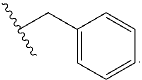 [SMILES: *Cc1ccccc1]

In some aspects, three R⁴ are

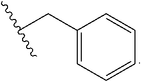 [SMILES: *Cc1ccccc1]

In some aspects, two R⁴ combine with each other to form a ring comprising an optionally substituted —(C₂-C₂₀ alkyl)— group together with the —O—Si—O— atoms to which they are bonded. In some aspects, two R⁴ combine with each other to form a ring comprising an optionally substituted —(C₂-C₈ alkyl)— group together with the —O—Si—O— atoms to which they are bonded. In some aspects, two R⁴ combine with each other to form a ring comprising an optionally substituted —(C₂-C₄ alkyl)— group together with the —O—Si—O— atoms to which they are bonded. In some aspects, two R⁴ combine with each other to form a ring comprising —CH₂CH₂CH(CH₃)— together with the —O—Si—O— atoms to which they are bonded.

In some aspects, R⁴ can be —(R⁵—O)ₘ—R⁶, in which each R⁵ is the same as or different from each other and each is a branched or unbranched C₁-C₃₀ divalent hydrocarbon group; R⁶ is a branched or unbranched C₁-C₃₀ alkyl group, a branched or unbranched C₂-C₃₀ alkenyl group, a C₆-C₃₀ aryl group, or a C₇-C₃₀ aralkyl group; and m is an integer of 1 to 30.

In some aspects, each R⁵ is the same as or different from each other and each is a branched or unbranched C₁-C₃₀ divalent hydrocarbon group In some aspects, each R⁵ is the same as or different from each other and each is a branched or unbranched C₁-C₁₀ divalent hydrocarbon group. In some aspects, each R⁵ is the same as or different from each other and each is a branched or unbranched C₁-C₃ divalent hydrocarbon group.

In some aspects, the hydrocarbon group of R⁵ include branched or unbranched C₁-C₃₀ alkylene groups, branched or unbranched C₂-C₃₀ alkenylene groups, branched or unbranched C₂-C₃₀ alkynylene groups, and C₆-C₃₀ arylene groups.

In some aspects, the branched or unbranched C₁-C₃₀ alkylene groups of R⁵ include methylene, ethylene, propylene, butylene, pentylene, hexylene, heptylene, octylene, nonylene, decylene, undecylene, dodecylene, tridecylene, tetradecylene, pentadecylene, hexadecylene, heptadecylene, and octadecylene groups.

In some aspects, the branched or unbranched C₂-C₃₀ alkenylene groups of R⁵ include vinylene, 1-propenylene, 2-propenylene, 1-butenylene, 2-butenylene, 1-pentenylene, 2-pentenylene, 1-hexenylene, 2-hexenylene, and 1-octenylene groups.

In some aspects, the branched or unbranched C₂-C₃₀ alkynylene groups of R⁵ include ethynylene, propynylene, butynylene, pentynylene, hexynylene, heptynylene, octynylene, nonynylene, decynylene, undecynylene, and dodecynylene groups.

In some aspects, the C₆-C₃₀ arylene groups of R⁵ include phenylene, tolylene, xylylene, and naphthylene groups.

In some aspects, R⁶ represents a branched or unbranched C₁-C₃₀ alkyl group, a branched or unbranched C₂-C₃₀ alkenyl group, a C₆-C₃₀ aryl group, or a C₇-C₃₀ aralkyl group.

In some aspects, the branched or unbranched C₁-C₃₀ alkyl groups of R⁶ include methyl, ethyl, n-propyl, isopropyl, n-butyl, iso-butyl, sec-butyl, tert-butyl, pentyl, hexyl, heptyl, 2-ethylhexyl, octyl, nonyl, decyl, undecyl, dodecyl, tridecyl, tetradecyl, pentadecyl, and octadecyl groups.

In some aspects, the branched or unbranched C₂-C₃₀ alkenyl groups of R⁶ include vinyl, 1-propenyl, 2-propenyl, 1-butenyl, 2-butenyl, 1-pentenyl, 2-pentenyl, 1-hexenyl, 2-hexenyl, 1-octenyl, decenyl, undecenyl, dodecenyl, tridecenyl, tetradecenyl, pentadecenyl, and octadecenyl groups.

In some aspects, the C₆-C₃₀ aryl groups of R⁶ include phenyl, tolyl, xylyl, naphthyl, and biphenyl groups.

In some aspects, the C₇-C₃₀ aralkyl groups of R⁶ include benzyl and phenethyl groups.

In some aspects, m represents an integer of 1 to 30. In some aspects, m represents an integer of 2 to 20. In some aspects, m represents an integer of 5 to 6.

In some aspects, —(R⁵—O)ₘ—R⁶ can be —O—(C₂H₄O)₅—C₁₁H₂₃, —O—(C₂H₄O)₅—C₁₂H₂₅, —O—(C₂H₄—O)₅—C₁₃H₂₇, —O—(C₂H₄—O)₅—C₁₄H₂₉, —O—(C₂H₄—O)₅—C₁₅H₃₁, —O—(C₂H₄O)₃—C₁₃H₂₇, —O—(C₂H₄—O)₄—C₁₃H₂₇, —O—(C₂H₄O)₆—C₁₃H₂₇, and —O—(C₂H₄O)₇—C₁₃H₂₇. In some aspects, —(R⁵—O)ₘ—R⁶ can be —O—(C₂H₄O)₅—C₁₁H₂₃, —O—(C₂H₄—O)₅—C₁₃H₂₇, —O—(C₂H₄—O)₅—C₁₅H₃₁, and —O—(C₂H₄O)₆—C₁₃H₂₇.

In some aspects, b is 2. In some aspects, b is 3.

In some aspects, the silane compound of Formula (I) is

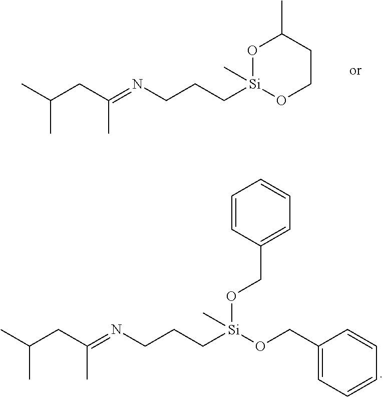 [SMILES: C/C(CC(C)C)=N\CCC[Si]1(C)OCCC(C)O1 ; C/C(CC(C)C)=N\CCC[Si](C)(OCc1ccccc1)OCc1ccccc1]

In some aspects, the silane compound of Formula (I) is

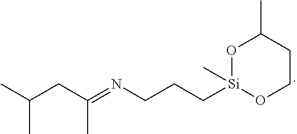 [SMILES: C/C(CC(C)C)=N\CCC[Si]1(C)OCCC(C)O1]

In some aspects, the silane compound of Formula (I) is

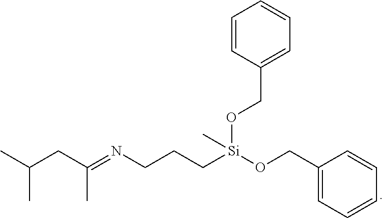 [SMILES: C/C(CC(C)C)=N\CCC[Si](C)(OCc1ccccc1)OCc1ccccc1]

### III. Silane Polymers

In some aspects, the present disclosure provides a silane polymer of Formula (II)

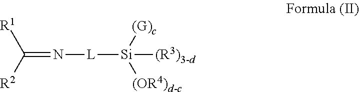

wherein
each R¹ and R² independently is hydrogen; an optionally substituted alkyl group having from 1 to 20 carbon atoms, where the optional substituent is one or more heteroatom; an optionally substituted alkenyl group having from 2 to 20 carbon atoms, where the optional substituents is one or more heteroatom; an optionally substituted cycloalkyl group having from 3 to 10 carbon atoms, where the optional substituent is one or more heteroatom; an optionally substituted aryl group having from 6 to 12 carbon atoms, where the optional substituent is one or more heteroatom; or an optionally substituted aralkyl group having from 7 to 16 carbon atoms, where the optional substituent is one or more heteroatom;
L is an optionally substituted alkylene group having from 1 to 20 carbon atoms, where the optional substituent is one or more heteroatom; an optionally substituted alkenylene group having from 2 to 20 carbon atoms, where the optional substituent is one or more heteroatom; an optionally substituted cycloalkylene group having from 3 to 10 carbon atoms, where the optional substituent is one or more heteroatom; an optionally substituted arylene group having from 6 to 12 carbon atoms, where the optional substituent is one or more heteroatom; or an optionally substituted aralkylene group having from 7 to 16 carbon atoms, where the optional substituent is one or more heteroatom;
R³ is an optionally substituted alkyl group having from 1 to 20 carbon atoms, where the optional substituent is one or more heteroatom; an optionally substituted alkenyl group having from 2 to 20 carbon atoms, where the optional substituent is one or more heteroatom; an optionally substituted cycloalkyl group having from 3 to 10 carbon atoms, where the optional substituent is one or more heteroatom; an optionally substituted aryl group having from 6 to 12 carbon atoms, where the optional substituent is one or more heteroatom; or an optionally substituted aralkyl group having from 7 to 16 carbon atoms, where the optional substituent is one or more heteroatom;
each R⁴ independently is an optionally substituted alkyl group having from 6 to 30 carbon atoms, where the optional substituent is one or more heteroatom; an optionally substituted alkenyl group having from 6 to 30 carbon atoms, where the optional substituent is one or more heteroatom; an optionally substituted alkynyl group having from 6 to 30 carbon atoms, where the optional substituent is one or more heteroatom; an optionally substituted cycloalkyl group having from 3 to 10 carbon atoms, where the optional substituent is one or more heteroatom; an optionally substituted aryl group having from 6 to 12 carbon atoms, where the optional substituent is one or more heteroatom; an optionally substituted aralkyl group having from 7 to 20 carbon atoms, where the optional substituent is one or more heteroatom; or an optionally substituted cyclic silane; or
R⁴ is R²³, where each R²³ independently is an optionally substituted straight chain or branched chain alkyl group, having from 1 to 10 carbon atoms, where two R²³ combine with each other to form a ring together with the —O—Si—O— atoms to which they are bonded, and where the optional substituent is one or more heteroatom, and wherein the two R²³ can be the same or different; or
each R⁴ independently is a group represented by —(R⁵—O)ₘ—R⁶, where each R⁵ is the same as or different from each other and each represents a branched or unbranched C₁-C₃₀ divalent hydrocarbon group; R⁶ represents a branched or unbranched C₁-C₃₀ alkyl group, a branched or unbranched C₂-C₃₀ alkenyl group, a C₆-C₃₀ aryl group, or a C₇-C₃₀ aralkyl group; and m is an integer of 1 to 30;
each G is independently a polymer fragment having a backbone of carbon atoms covalently bonded together by C—C single bond, C═C double bond, or a combination of C—C single bonds and C═C double bonds;
c is 1 or 2, with the proviso that c is equal to or less than d; and
d is 1, 2, or 3.

In some aspects, R¹ is a C₁-C₂₀ alkyl. In some aspects, R¹ is a C₁-C₁₀ alkyl. In some aspects, R¹ is a C₁-C₅ alkyl. In some aspects, R¹ is a C₄ alkyl. In some aspects, R¹ is —CH₂CH(CH₃)₂.

In some aspects, R² is an optionally substituted alkyl group having from 1 to 20 carbon atoms, where the optional substituent is one or more heteroatom. In some aspects, the heteroatom is N, O, or S.

In some aspects, R² is a C₁-C₂₀ alkyl. In some aspects, R² is a C₁-C₁₀ alkyl. In some aspects, R² is a C₁-C₅ alkyl. In some aspects, R² is methyl.

In some aspects, L is an optionally substituted alkyl group having from 1 to 20 carbon atoms and optionally at least one heteroatom. In some aspects, the heteroatom is N, O, or S.

In some aspects, L is a C₁-C₁₂ alkylene. In some aspects, L is a C₁-C₈ alkylene. In some aspects, L is a C₁-C₄ alkylene. In some aspects, L is a C₃ alkylene. In some aspects, L is —CH₂CH₂CH₂—.

In some aspects, R³ is an optionally substituted alkyl group having from 1 to 20 carbon atoms, where the optional substituent is one or more heteroatom. In some aspects, the heteroatom is N, O, or S.

In some aspects, R³ is a C₁-C₂₀ alkyl. In some aspects, R³ is a C₁-C₁₀ alkyl. In some aspects, R³ is a C₁-C₅ alkyl. In some aspects, R³ is methyl.

In some aspects, each R⁴ is different. In some aspects, two R⁴ groups are the same. In some aspects, three R⁴ groups are the same.

In some aspects, at least one R⁴ is an optionally substituted aralkyl group having from 7 to 20 carbon atoms, where the optional substituent is one or more heteroatom. In some aspects, the heteroatom is N, O, or S.

In some aspects, one R⁴ is an optionally substituted aralkyl group having from 7 to 20 carbon atoms, where the optional substituent is one or more heteroatom, and wherein the heteroatom is N, O, or S. In some aspects, two R⁴ are an optionally substituted aralkyl group having from 7 to 20 carbon atoms, where the optional substituent is one or more heteroatom, and wherein the heteroatom is N, O, or S. In some aspects, three R⁴ are an optionally substituted aralkyl group having from 7 to 20 carbon atoms, where the optional substituent is one or more heteroatom, and wherein the heteroatom is N, O, or S.

In some aspects, at least one R⁴ is an optionally substituted aralkyl group having from 7 to 20 carbon atoms.

In some aspects, one R⁴ is an optionally substituted aralkyl group having from 7 to 20 carbon atoms. In some aspects, two R⁴ are an optionally substituted aralkyl group having from 7 to 20 carbon atoms. In some aspects, three R⁴ are an optionally substituted aralkyl group having from 7 to 20 carbon atoms.

In some aspects, two R⁴ are a C₇-C₂₀ aralkyl. In some aspects, two R⁴ are

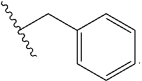 [SMILES: *Cc1ccccc1]

In some aspects, two R⁴ combine with each other to form a ring comprising an optionally substituted —(C₂-C₂₀ alkyl)— group together with the —O—Si—O— atoms to which they are bonded. In some aspects, two R⁴ combine with each other to form a ring comprising an optionally substituted —(C₂-C₈ alkyl)— group together with the —O—Si—O— atoms to which they are bonded. In some aspects, two R⁴ combine with each other to form a ring comprising an optionally substituted —(C₂-C₄ alkyl)— group together with the —O—Si—O— atoms to which they are bonded. In some aspects, two R⁴ combine with each other to form a ring comprising —CH₂CH₂CH(CH₃)— together with the —O—Si—O— atoms to which they are bonded.

In some aspects, R⁴ can be —(R⁵—O)ₘ—R⁶, in which each R⁵ is the same as or different from each other and each is a branched or unbranched C₁-C₃₀ divalent hydrocarbon group; R⁶ is a branched or unbranched C₁-C₃₀ alkyl group, a branched or unbranched C₂-C₃₀ alkenyl group, a C₆-C₃₀ aryl group, or a C₇-C₃₀ aralkyl group; and m is an integer of 1 to 30.

In some aspects, R⁵ is the same as or different from each other and each is a branched or unbranched C₁-C₁₀ divalent hydrocarbon group. In some aspects, R⁵ is the same as or different from each other and each is a branched or unbranched C₁-C₃₀ divalent hydrocarbon group.

In some aspects, the hydrocarbon group of R⁵ can be branched or unbranched C₁-C₃₀ alkylene, branched or unbranched C₂-C₃₀ alkenylene groups, branched or unbranched C₂-C₃₀ alkynylene groups, and C₆-C₃₀ arylene groups.

In some aspects, the branched or unbranched C₁-C₃₀ alkylene groups of R⁵ can be methylene, ethylene, propylene, butylene, pentylene, hexylene, heptylene, octylene, nonylene, decylene, undecylene, dodecylene, tridecylene, tetradecylene, pentadecylene, hexadecylene, heptadecylene, and octadecylene groups.

In some aspects, the branched or unbranched C₂-C₃₀ alkenylene groups of R⁵ can be vinylene, 1-propenylene, 2-propenylene, 1-butenylene, 2-butenylene, 1-pentenylene, 2-pentenylene, 1-hexenylene, 2-hexenylene, and 1-octenylene groups.

In some aspects, the branched or unbranched C₂-C₃₀ alkynylene groups of R⁵ can be ethynylene, propynylene, butynylene, pentynylene, hexynylene, heptynylene, octynylene, nonynylene, decynylene, undecynylene, and dodecynylene groups.

In some aspects, the C₆-C₃₀ arylene groups of R⁵ can be phenylene, tolylene, xylylene, and naphthylene groups.

In some aspects, m represents an integer of 1 to 30. In some aspects, m represents an integer of 2 to 20. In some aspects, m represents an integer of 5 to 6.

In some aspects, R⁶ represents a branched or unbranched C₁-C₃₀ alkyl group, a branched or unbranched C₂-C₃₀ alkenyl group, a C₆-C₃₀ aryl group, or a C₇-C₃₀ aralkyl group.

In some aspects, the branched or unbranched C₁-C₃₀ alkyl groups of R⁶ can be methyl, ethyl, n-propyl, isopropyl, n-butyl, iso-butyl, sec-butyl, tert-butyl, pentyl, hexyl, heptyl, 2-ethylhexyl, octyl, nonyl, decyl, undecyl, dodecyl, tridecyl, tetradecyl, pentadecyl, and octadecyl groups.

In some aspects, the branched or unbranched C₂-C₃₀ alkenyl groups of R⁶ can be vinyl, 1-propenyl, 2-propenyl, 1-butenyl, 2-butenyl, 1-pentenyl, 2-pentenyl, 1-hexenyl, 2-hexenyl, 1-octenyl, decenyl, undecenyl, dodecenyl, tridecenyl, tetradecenyl, pentadecenyl, and octadecenyl groups.

In some aspects, the C₆-C₃₀ aryl groups of R⁶ can be phenyl, tolyl, xylyl, naphthyl, and biphenyl groups.

In some aspects, the C₇-C₃₀ aralkyl groups of R⁶ can be benzyl and phenethyl groups.

In some aspects, —(R⁵—O)ₘ—R⁶ can be —O—(C₂H₄—O)₅—C₁₁H₂₃, —O—(C₂H₄—O)₅—C₁₂H₂₅, —O—(C₂H₄—O)₅—C₁₃H₂₇, —O—(C₂H₄—O)₅—C₁₄H₂₉, —O—(C₂H₄—O)₅—C₁₅H₃₁, —O—(C₂H₄—O)₃—C₁₃H₂₇, —O—(C₂H₄—O)₄—C₁₃H₂₇, —O—(C₂H₄—O)₆—C₁₃H₂₇, and —O—(C₂H₄—O)₇—C₁₃H₂₇. In some aspects, —(R⁵—O)ₘ—R⁶ can be —O—(C₂H₄—O)₅—C₁₁H₂₃, —O—(C₂H₄—O)₅—C₁₃H₂₇, —O—(C₂H₄—O)₅—C₁₅H₃₁, and —O—(C₂H₄—O)₆—C₁₃H₂₇.

In some aspects, c is 1. In some aspects, c is 2.

In some aspects, d is 1. In some aspects, dis 2. In some aspects, d is 3.

In some aspects, each G is styrene butadiene polymer.

In some aspects, G is a polymer fragment of Formula (III)

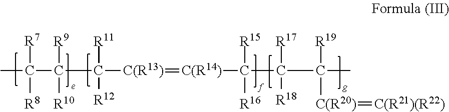

wherein
each R⁷, R⁸, R⁹, R¹¹, R¹², R¹³, R¹⁴, R¹⁵, R¹⁶, R¹⁷, R¹⁸, R¹⁹, R²⁰, R²¹, and R²² independently is hydrogen or an alkyl group having from 1 to 20 carbon atoms;
each R¹⁰ independently is hydrogen, an alkyl group having from 1 to 20 carbon atoms and optionally at least one heteroatom, an alkenyl group having from 2 to 20 carbon atoms, a cycloalkyl group having from 3 to 14 carbon atoms, a cycloalkenyl group having from 4 to 14 carbon atoms, an aryl group having from 6 to 16 carbon atoms, or an aralkyl group having from 7 to 20 carbon atoms; and
f, g and h are integers, wherein f is equal to or greater than 0, g is equal to or greater than 0, and h is equal to or greater than 0, with the proviso that the sum of f, g and h is equal to or greater than 1.

In some aspects, f is from 0 to 10,000. In some aspects, f is from 1 to 5,000. In some aspects, f is from 100 to 2,500.

In some aspects, g is from 0 to 10,000. In some aspects, g is from 0 to 5,000. In some aspects, g is from 100 to 2,500.

In some aspects, h is from 0 to 10,000. In some aspects, h is from 0 to 5,000. In some aspects, h is from 100 to 2,500.

In some aspects, the sum of f, g and h is from 100 to 5,000.

In some aspects, the polymer of Formula (II) is

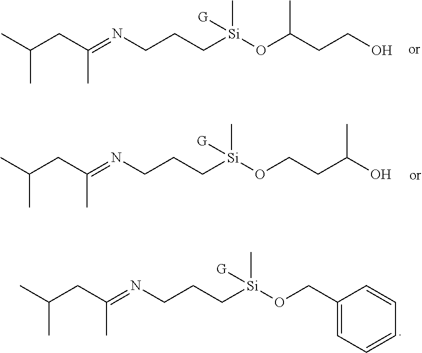

In some aspects, the polymer of Formula (II) is

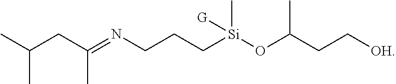

In some aspects, the polymer of Formula (II) is

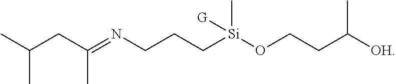

In some aspects, the polymer of Formula (II) is

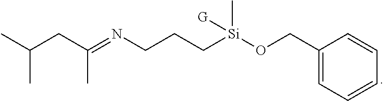

In some aspects, the present disclosure provides a polymer represented by Formula (IV)

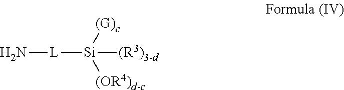

wherein
L is an optionally substituted alkylene group having from 1 to 20 carbon atoms, where the optional substituent is one or more heteroatom; an optionally substituted alkenylene group having from 2 to 20 carbon atoms, where the optional substituent is one or more heteroatom; an optionally substituted cycloalkylene group having from 3 to 10 carbon atoms, where the optional substituent is one or more heteroatom; an optionally substituted arylene group having from 6 to 12 carbon atoms, where the optional substituent is one or more heteroatom; or an optionally substituted aralkylene group having from 7 to 16 carbon atoms, where the optional substituent is one or more heteroatom;
R³ is an optionally substituted alkyl group having from 1 to 20 carbon atoms, where the optional substituent is one or more heteroatom; an optionally substituted alkenyl group having from 2 to 20 carbon atoms, where the optional substituent is one or more heteroatom; an optionally substituted cycloalkyl group having from 3 to 10 carbon atoms, where the optional substituent is one or more heteroatom; an optionally substituted aryl group having from 6 to 12 carbon atoms, where the optional substituent is one or more heteroatom; or an optionally substituted aralkyl group having from 7 to 16 carbon atoms, where the optional substituent is one or more heteroatom;
each R⁴ independently is an optionally substituted alkyl group having from 6 to 30 carbon atoms, where the optional substituent is one or more heteroatom; an optionally substituted alkenyl group having from 6 to 30 carbon atoms, where the optional substituent is one or more heteroatom; an optionally substituted alkynyl group having from 6 to 30 carbon atoms, where the optional substituent is one or more heteroatom; an optionally substituted cycloalkyl group having from 3 to 10 carbon atoms, where the optional substituent is one or more heteroatom; an optionally substituted aryl group having from 6 to 12 carbon atoms, where the optional substituent is one or more heteroatom; an optionally substituted aralkyl group having from 7 to 20 carbon atoms, where the optional substituent is one or more heteroatom; or an optionally substituted cyclic silane; or
R⁴ is R²³, where each R²³ independently is an optionally substituted straight chain or branched chain alkyl group, having from 1 to 10 carbon atoms, where two R²³ combine with each other to form a ring together with the —O—Si—O— atoms to which they are bonded, and where the optional substituent is one or more heteroatom, and wherein the two R²³ can be the same or different; or
each R⁴ independently is a group represented by —(R⁵—O)ₘ—R⁶, where each R⁵ is the same as or different from each other and each represents a branched or unbranched C₁-C₃₀ divalent hydrocarbon group; R⁶ represents a branched or unbranched C₁-C₃₀ alkyl group, a branched or unbranched C₂-C₃₀ alkenyl group, a C₆-C₃₀ aryl group, or a C₇-C₃₀ aralkyl group; and m is an integer of 1 to 30;
c is 1 or 2, with the proviso that c is equal to or less than d;
d is 2 or 3; and

each G is independently a polymer fragment having a backbone of carbon atoms covalently bonded together by C—C single bond, C═C double bond, or a combination of C—C single bonds and C═C double bonds.

In some aspects, L is an optionally substituted alkyl group having from 1 to 20 carbon atoms and optionally at least one heteroatom, wherein the heteroatom is N, O, or S.

In some aspects, L is a C₁-C₁₂ alkylene. In some aspects, L is a C₁-C₈ alkylene. In some aspects, L is a C₁-C₄ alkylene. In some aspects, L is a C₃ alkylene. In some aspects, L is —CH₂CH₂CH₂—.

In some aspects, R³ is an optionally substituted alkyl group having from 1 to 20 carbon atoms, where the optional substituent is one or more heteroatom. In some aspects, the heteroatom is N, O, or S.

In some aspects, R³ is a C₁-C₂₀ alkyl. In some aspects, R³ is a C₁-C₁₀ alkyl. In some aspects, R³ is a C₁-C₅ alkyl. In some aspects, R³ is methyl.

In some aspects, each R⁴ is different. In some aspects, two R⁴ groups are the same. In some aspects, three R⁴ groups are the same.

In some aspects, at least one R⁴ is an optionally substituted aralkyl group having from 7 to 20 carbon atoms, where the optional substituent is one or more heteroatom. In some aspects, the heteroatom is N, O, or S.

In some aspects, one R⁴ is an optionally substituted aralkyl group having from 7 to 20 carbon atoms, where the optional substituent is one or more heteroatom, and wherein the heteroatom is N, O, or S. In some aspects, two R⁴ are an optionally substituted aralkyl group having from 7 to 20 carbon atoms, where the optional substituent is one or more heteroatom, and wherein the heteroatom is N, O, or S. In some aspects, three R⁴ are an optionally substituted aralkyl group having from 7 to 20 carbon atoms, where the optional substituent is one or more heteroatom, and wherein the heteroatom is N, O, or S.

In some aspects, at least one R⁴ is an optionally substituted aralkyl group having from 7 to 20 carbon atoms.

In some aspects, one R⁴ is an optionally substituted aralkyl group having from 7 to 20 carbon atoms. In some aspects, two R⁴ are an optionally substituted aralkyl group having from 7 to 20 carbon atoms. In some aspects, three R⁴ are an optionally substituted aralkyl group having from 7 to 20 carbon atoms.

In some aspects, two R⁴ are a C₇-C₂₀ aralkyl. In some aspects, two R⁴ are

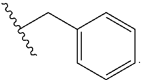 [SMILES: *Cc1ccccc1]

In some aspects, two R⁴ combine with each other to form a ring comprising an optionally substituted —(C₂-C₁₀ alkyl)— group together with the —O—Si—O— atoms to which they are bonded. In some aspects, two R⁴ combine with each other to form a ring comprising an optionally substituted —(C₂-C₈ alkyl)— group together with the —O—Si—O— atoms to which they are bonded. In some aspects, two R⁴ combine with each other to form a ring comprising an optionally substituted —(C₂-C₄ alkyl)— group together with the —O—Si—O— atoms to which they are bonded. In some aspects, two R⁴ combine with each other to form a ring comprising —CH₂CH₂CH(CH₃)— together with the —O—Si—O— atoms to which they are bonded.

In some aspects, R⁴ can be —(R⁵—O)ₘ—R⁶, in which each R⁵ is the same as or different from each other and each is a branched or unbranched C₁-C₃₀ divalent hydrocarbon group; R⁶ is a branched or unbranched C₁-C₃₀ alkyl group, a branched or unbranched C₂-C₃₀ alkenyl group, a C₆-C₃₀ aryl group, or a C₇-C₃₀ aralkyl group; and m is an integer of 1 to 30.

In some aspects, R⁵ is the same as or different from each other and each is a branched or unbranched C₁-C₃₀ divalent hydrocarbon group. In some aspects, R⁵ is the same as or different from each other and each is a branched or unbranched C₁-C₁₀ divalent hydrocarbon group. In some aspects, R⁵ is the same as or different from each other and each is a branched or unbranched C₁-C₃ divalent hydrocarbon group.

In some aspects, the hydrocarbon group of R⁵ can be branched or unbranched C₁-C₃₀ alkylene groups, branched or unbranched C₂-C₃₀ alkenylene groups, branched or unbranched C₂-C₃₀ alkynylene groups, and C₆-C₃₀ arylene groups.

In some aspects, the branched or unbranched C₁-C₃₀ alkylene groups of R⁵ can be methylene, ethylene, propylene, butylene, pentylene, hexylene, heptylene, octylene, nonylene, decylene, undecylene, dodecylene, tridecylene, tetradecylene, pentadecylene, hexadecylene, heptadecylene, and octadecylene groups.

In some aspects, the branched or unbranched C₂-C₃₀ alkenylene groups of R⁵ can be vinylene, 1-propenylene, 2-propenylene, 1-butenylene, 2-butenylene, 1-pentenylene, 2-pentenylene, 1-hexenylene, 2-hexenylene, and 1-octenylene groups.

In some aspects, the branched or unbranched C₂-C₃₀ alkynylene groups of R⁵ can be ethynylene, propynylene, butynylene, pentynylene, hexynylene, heptynylene, octynylene, nonynylene, decynylene, undecynylene, and dodecynylene groups.

In some aspects, the C₆-C₃₀ arylene groups of R⁵ can be phenylene, tolylene, xylylene, and naphthylene groups.

In some aspects, m represents an integer of 1 to 30. In some aspects, m represents an integer of 2 to 20. In some aspects, m represents an integer of 5 to 6.

In some aspects, R⁶ represents a branched or unbranched C₁-C₃₀ alkyl group, a branched or unbranched C₂-C₃₀ alkenyl group, a C₆-C₃₀ aryl group, or a C₇-C₃₀ aralkyl group.

In some aspects, the branched or unbranched C₁-C₃₀ alkyl groups of R⁶ can be methyl, ethyl, n-propyl, isopropyl, n-butyl, iso-butyl, sec-butyl, tert-butyl, pentyl, hexyl, heptyl, 2-ethylhexyl, octyl, nonyl, decyl, undecyl, dodecyl, tridecyl, tetradecyl, pentadecyl, and octadecyl groups.

In some aspects, the branched or unbranched C₂-C₃₀ alkenyl groups of R⁶ can be vinyl, 1-propenyl, 2-propenyl, 1-butenyl, 2-butenyl, 1-pentenyl, 2-pentenyl, 1-hexenyl, 2-hexenyl, 1-octenyl, decenyl, undecenyl, dodecenyl, tridecenyl, tetradecenyl, pentadecenyl, and octadecenyl groups.

In some aspects, the C₆-C₃₀ aryl groups of R⁶ can be phenyl, tolyl, xylyl, naphthyl, and biphenyl groups.

In some aspects, the C₇-C₃₀ aralkyl groups of R⁶ can be benzyl and phenethyl groups.

In some aspects, —(R⁵—O)ₘ—R⁶ can be —O—(C₂H₄—O)₅—C₁₁H₂₃, —O—(C₂H₄—O)₅—C₁₂H₂₅, —O—(C₂H₄—O)₅—C₁₃H₂₇, —O—(C₂H₄—O)₅—C₁₄H₂₉, —O—(C₂H₄—O)₅—C₁₅H₃₁, —O—(C₂H₄—O)₃—C₁₃H₂₇, —O—(C₂H₄—O)₄—C₁₃H₂₇, —O—(C₂H₄—O)₆—C₁₃H₂₇, and —O—(C₂H₄—O)₇—C₁₃H₂₇. In some aspects, —(R⁵—O)ₘ—R⁶ can be —O—(C₂H₄—O)₅—C₁₁H₂₃, —O—(C₂H₄—O)₅—C₁₃H₂₇, —O—(C₂H₄—O)₅—C₁₅H₃₁, and —O—(C₂H₄—O)₆—C₁₃H₂₇.

In some aspects, c is 1. In some aspects, c is 2.

In some aspects, d is 1. In some aspects, d is 2. In some aspects, d is 3.

In some aspects, each G is styrene butadiene polymer.

In some aspects, G is a polymer fragment of Formula (III)

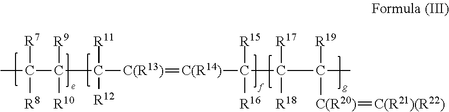

wherein
each R⁷, R⁸, R⁹, R¹¹, R¹², R¹³, R¹⁴, R¹⁵, R¹⁶, R¹⁷, R¹⁸, R¹⁹, R²⁰, R²¹, and R²² independently is hydrogen or an alkyl group having from 1 to 20 carbon atoms;
each R¹⁰ independently is hydrogen, an alkyl group having from 1 to 20 carbon atoms and optionally at least one heteroatom, an alkenyl group having from 2 to 20 carbon atoms, a cycloalkyl group having from 3 to 14 carbon atoms, a cycloalkenyl group having from 4 to 14 carbon atoms, an aryl group having from 6 to 16 carbon atoms, or an aralkyl group having from 7 to 20 carbon atoms; and
f, g and h are integers, wherein f is equal to or greater than 0, g is equal to or greater than 0, and h is equal to or greater than 0, with the proviso that the sum of f, g and h is equal to or greater than 1.

In some aspects, f is from 0 to 10,000. In some aspects, f is from 1 to 5,000. In some aspects, f is from 100 to 2,500.

In some aspects, g is from 0 to 10,000. In some aspects, g is from 0 to 5,000. In some aspects, g is from 100 to 2,500.

In some aspects, h is from 0 to 10,000. In some aspects, h is from 0 to 5,000. In some aspects, h is from 100 to 2,500.

In some aspects, the sum of f, g and h is from 100 to 5,000.

In some aspects, the polymer of Formula (IV) is

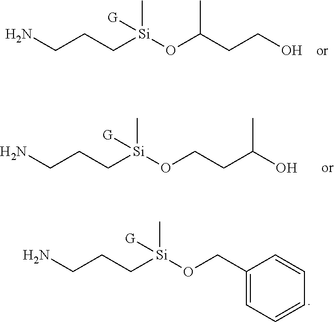

In some aspects, the polymer of Formula (IV) is

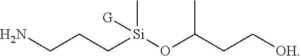

In some aspects, the polymer of Formula (IV) is

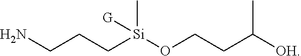

In some aspects, the polymer of Formula (IV) is

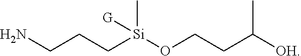

### IV. Methods of Making Silane Compounds

In some aspects, the present disclosure provides a method of making the silane compound of Formula (I)

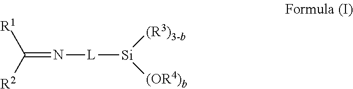

comprising:
reacting a compound of Formula (V)

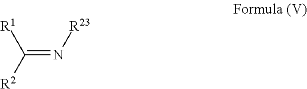

with a compound of Formula (VI)

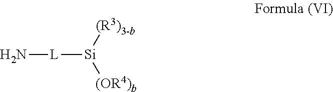

wherein
each R¹ and R² independently is hydrogen; an optionally substituted alkyl group having from 1 to 20 carbon atoms, where the optional substituent is one or more heteroatom; an optionally substituted alkenyl group having from 2 to 20 carbon atoms, where the optional substituents is one or more heteroatom; an optionally substituted cycloalkyl group having from 3 to 10 carbon atoms, where the optional substituent is one or more heteroatom; an optionally substituted aryl group having from 6 to 12 carbon atoms, where the optional substituent is one or more heteroatom; or an optionally substituted aralkyl group having from 7 to 16 carbon atoms, where the optional substituent is one or more heteroatom;
L is an optionally substituted alkylene group having from 1 to 20 carbon atoms, where the optional substituent is one or more heteroatom; an optionally substituted alkenylene group having from 2 to 20 carbon atoms, where the optional substituent is one or more heteroatom; an optionally substituted cycloalkylene group having from 3 to 10 carbon atoms, where the optional substituent is one or more heteroatom; an optionally substituted arylene group having from 6 to 12 carbon atoms, where the optional substituent is one or more heteroatom; or an optionally substituted aralkylene group having from 7 to 16 carbon atoms, where the optional substituent is one or more heteroatom;
R³ is an optionally substituted alkyl group having from 1 to 20 carbon atoms, where the optional substituent is one or more heteroatom; an optionally substituted alkenyl group having from 2 to 20 carbon atoms, where the optional substituent is one or more heteroatom; an optionally substituted cycloalkyl group having from 3 to 10 carbon atoms, where the optional substituent is one or more heteroatom; an optionally substituted aryl group having from 6 to 12 carbon atoms, where the optional substituent is one or more heteroatom; or an optionally substituted aralkyl group having from 7 to 16 carbon atoms, where the optional substituent is one or more heteroatom;
each R⁴ independently is an optionally substituted alkyl group having from 6 to 30 carbon atoms, where the optional substituent is one or more heteroatom; an optionally substituted alkenyl group having from 6 to 30 carbon atoms, where the optional substituent is one or more heteroatom; an optionally substituted alkynyl group having from 6 to 30 carbon atoms, where the optional substituent is one or more heteroatom; an optionally substituted cycloalkyl group having from 3 to 10 carbon atoms, where the optional substituent is one or more heteroatom; an optionally substituted aryl group having from 6 to 12 carbon atoms, where the optional substituent is one or more heteroatom; an optionally substituted aralkyl group having from 7 to 20 carbon atoms, where the optional substituent is one or more heteroatom; or an optionally substituted cyclic silane; or
R⁴ is R²³, where each R²³ independently is an optionally substituted straight chain or branched chain alkyl group, having from 1 to 10 carbon atoms, where two R²³ combine with each other to form a ring together with the —O—Si—O— atoms to which they are bonded, and where the optional substituent is one or more heteroatom, and wherein the two R²³ can be the same or different; or
each R⁴ independently is a group represented by —(R⁵—O)ₘ—R⁶, where each R⁵ is the same as or different from each other and each represents a branched or unbranched C₁-C₃₀ divalent hydrocarbon group; R⁶ represents a branched or unbranched C₁-C₃₀ alkyl group, a branched or unbranched C₂-C₃₀ alkenyl group, a C₆-C₃₀ aryl group, or a C₇-C₃₀ aralkyl group; and m is an integer of 1 to 30; and
b is 2 or 3; and

In some aspects, R¹ is an optionally substituted alkyl group having from 1 to 20 carbon atoms, where the optional substituent is one or more heteroatom. In some aspects, the heteroatom is N, O, or S.

In some aspects, R¹ is a C₁-C₂₀ alkyl. In some aspects, R¹ is a C₁-C₁₀ alkyl. In some aspects, R¹ is a C₁-C₅ alkyl. In some aspects, R¹ is a C₄ alkyl. In some aspects, R¹ is —CH₂CH(CH₃)₂.

In some aspects, R² is an optionally substituted alkyl group having from 1 to 20 carbon atoms, where the optional substituent is one or more heteroatom. In some aspects, the heteroatom is N, O, or S.

In some aspects, R² is a C₁-C₂₀ alkyl. In some aspects, R² is a C₁-C₁₀ alkyl. In some aspects, R² is a C₁-C₅ alkyl. In some aspects, R² is methyl.

In some aspects, L is an optionally substituted alkyl group having from 1 to 20 carbon atoms, where the optional substituent is one or more heteroatom. In some aspects, the heteroatom is N, O, or S.

In some aspects, L is a C₁-C₁₂ alkylene. In some aspects, L is a C₁-C₈ alkylene. In some aspects, L is a C₁-C₄ alkylene. In some aspects, L is a C₃ alkylene. In some aspects, L is —CH₂CH₂CH₂—.

In some aspects, R³ is an optionally substituted alkyl group having from 1 to 20 carbon atoms, where the optional substituent is one or more heteroatom. In some aspects, the heteroatom is N, O, or S.

In some aspects, R³ is a C₁-C₂₀ alkyl. In some aspects, R³ is a C₁-C₁₀ alkyl. In some aspects, R³ is a C₁-C₅ alkyl. In some aspects, R³ is methyl.

In some aspects, each R⁴ is different. In some aspects, two R⁴ groups are the same. In some aspects, three R⁴ groups are the same.

In some aspects, at least one R⁴ is an optionally substituted aralkyl group having from 7 to 20 carbon atoms where the optional substituent is one or more heteroatom. In some aspects, the heteroatom is N, O, or S.

In some aspects, one R⁴ is an optionally substituted aralkyl group having from 7 to 20 carbon atoms, where the optional substituent is one or more heteroatom, and wherein the heteroatom is N, O, or S. In some aspects, two R⁴ are an optionally substituted aralkyl group having from 7 to 20 carbon atoms, where the optional substituent is one or more heteroatom, and wherein the heteroatom is N, O, or S. In some aspects, three R⁴ are an optionally substituted aralkyl group having from 7 to 20 carbon atoms, where the optional substituent is one or more heteroatom, and wherein the heteroatom is N, O, or S.

In some aspects, at least one R⁴ is an optionally substituted aralkyl group having from 7 to 20 carbon atoms.

In some aspects, one R⁴ is an optionally substituted aralkyl group having from 7 to 20 carbon atoms. In some aspects, two R⁴ are an optionally substituted aralkyl group having from 7 to 20 carbon atoms. In some aspects, three R⁴ are an optionally substituted aralkyl group having from 7 to 20 carbon atoms.

In some aspects, two R⁴ are a C₇-C₂₀ aralkyl. In some aspects, two R⁴ are

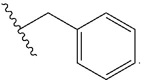 [SMILES: *Cc1ccccc1]

In some aspects, three R⁴ are

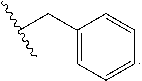 [SMILES: *Cc1ccccc1]

In some aspects, two R⁴ combine with each other to form a ring comprising an optionally substituted —(C₂-C₁₀ alkyl)— group together with the —O—Si—O— atoms to which they are bonded. In some aspects, two R⁴ combine with each other to form a ring comprising an optionally substituted —(C₂-C₈ alkyl)— group together with the —O—Si—O— atoms to which they are bonded. In some aspects, two R⁴ combine with each other to form a ring comprising an optionally substituted —(C₂-C₄ alkyl)— group together with the —O—Si—O— atoms to which they are bonded. In some aspects, two R⁴ combine with each other to form a ring comprising —CH₂CH₂CH(CH₃)— together with the —O—Si—O— atoms to which they are bonded.

In some aspects, R⁴ can be —(R⁵—O)ₘ—R⁶, in which each R⁵ is the same as or different from each other and each is a branched or unbranched C₁-C₃₀ divalent hydrocarbon group; R⁶ is a branched or unbranched C₁-C₃₀ alkyl group, a branched or unbranched C₂-C₃₀ alkenyl group, a C₆-C₃₀ aryl group, or a C₇-C₃₀ aralkyl group; and m is an integer of 1 to 30.

In some aspects, each R⁵ is the same as or different from each other and each is a branched or unbranched C₁-C₃₀ divalent hydrocarbon group. In some aspects, each R⁵ is the same as or different from each other and each is a branched or unbranched C₁-C₁₀ divalent hydrocarbon group. In some aspects, each R⁵ is the same as or different from each other and each is a branched or unbranched C₁-C₃ divalent hydrocarbon group.

In some aspects, the hydrocarbon group of R⁵ include branched or unbranched C₁-C₃₀ alkylene groups, branched or unbranched C₂-C₃₀ alkenylene groups, branched or unbranched C₂-C₃₀ alkynylene groups, and C₆-C₃₀ arylene groups.

In some aspects, the branched or unbranched C₁-C₃₀ alkylene groups of R⁵ include methylene, ethylene, propylene, butylene, pentylene, hexylene, heptylene, octylene, nonylene, decylene, undecylene, dodecylene, tridecylene, tetradecylene, pentadecylene, hexadecylene, heptadecylene, and octadecylene groups.

In some aspects, the branched or unbranched C₂-C₃₀ alkenylene groups of R⁵ include vinylene, 1-propenylene, 2-propenylene, 1-butenylene, 2-butenylene, 1-pentenylene, 2-pentenylene, 1-hexenylene, 2-hexenylene, and 1-octenylene groups.

In some aspects, the branched or unbranched C₂-C₃₀ alkynylene groups of R⁵ include ethynylene, propynylene, butynylene, pentynylene, hexynylene, heptynylene, octynylene, nonynylene, decynylene, undecynylene, and dodecynylene groups.

In some aspects, the C₆-C₃₀ arylene groups of R⁵ include phenylene, tolylene, xylylene, and naphthylene groups.

In some aspects, R⁶ represents a branched or unbranched C₁-C₃₀ alkyl group, a branched or unbranched C₂-C₃₀ alkenyl group, a C₆-C₃₀ aryl group, or a C₇-C₃₀ aralkyl group.

In some aspects, the branched or unbranched C₁-C₃₀ alkyl groups of R⁶ include methyl, ethyl, n-propyl, isopropyl, n-butyl, iso-butyl, sec-butyl, tert-butyl, pentyl, hexyl, heptyl, 2-ethylhexyl, octyl, nonyl, decyl, undecyl, dodecyl, tridecyl, tetradecyl, pentadecyl, and octadecyl groups.

In some aspects, the branched or unbranched C₂-C₃₀ alkenyl groups of R⁶ include vinyl, 1-propenyl, 2-propenyl, 1-butenyl, 2-butenyl, 1-pentenyl, 2-pentenyl, 1-hexenyl, 2-hexenyl, 1-octenyl, decenyl, undecenyl, dodecenyl, tridecenyl, tetradecenyl, pentadecenyl, and octadecenyl groups.

In some aspects, the C₆-C₃₀ aryl groups of R⁶ include phenyl, tolyl, xylyl, naphthyl, and biphenyl groups.

In some aspects, the C₇-C₃₀ aralkyl groups of R⁶ include benzyl and phenethyl groups.

In some aspects, m represents an integer of 1 to 30. In some aspects, m represents an integer of 2 to 20. In some aspects, m represents an integer of 5 to 6.

In some aspects, —(R⁵—O)ₘ—R⁶ can be —O—(C₂H₄—O)₅—C₁₁H₂₃, —O—(C₂H₄—O)₅—C₁₂H₂₅, —O—(C₂H₄—O) s-C₁₃H₂₇, —O—(C₂H₄—O) s-C₁₄H₂₉, —O—(C₂H₄—O)₅—C₁₅H₃₁, —O—(C₂H₄—O)₃—C₁₃H₂₇, —O—(C₂H₄—O)₄—C₁₃H₂₇, —O—(C₂H₄—O)₆—C₁₃H₂₇, and —O—(C₂H₄—O)₇—C₁₃H₂₇. In some aspects, —(R⁵—O)ₘ—R⁶ can be —O—(C₂H₄—O)₅—C₁₁H₂₃, —O—(C₂H₄—O) s-C₁₃H₂₇, —O—(C₂H₄—O) s-C₁₅H₃₁, and —O—(C₂H₄—O)₆—C₁₃H₂₇.

In some aspects, b is 2. In some aspects, b is 3.

In some aspects, wherein
(a) when two R⁴ are

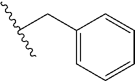 [SMILES: *Cc1ccccc1]

and b is 2, the silane compound of Formula (I) is

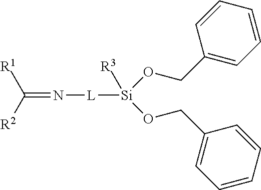

and is prepared by reacting the compound of Formula (V)

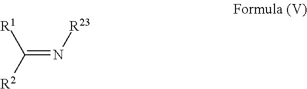

with a compound of Formula (VI) which is

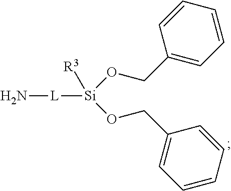

or
(b) when two R²³ combine with each other to form a ring
   comprising —CH₂CH₂CH(CH₃)— together with the —O—Si—O— atoms to which they are bonded, the silane compound of Formula (I) is

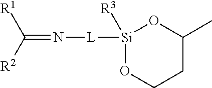

and is prepared by reacting the compound of Formula (V)

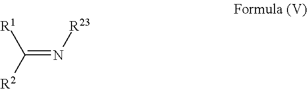

with a compound of Formula (VI) which is

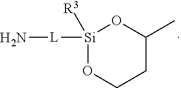

### V. Method of Making Silane Polymers

In some aspects, the present disclosure provides a method of making a polymer represented by Formula (II)

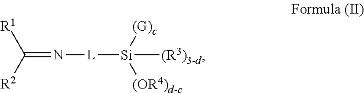

prepared by
(i) reacting a polymer fragment having a backbone of carbon atoms covalently bonded together by C—C single bond, C═C double bond, or a combination of C—C single bonds and C═C double bonds with an anionic initiator to form a polymer fragment G; and
(ii) reacting the polymer fragment G of (i) with a silane compound of Formula (I)

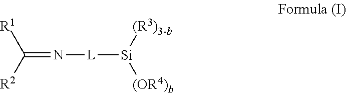

wherein
each R¹ and R² independently is hydrogen; an optionally substituted alkyl group having from 1 to 20 carbon atoms, where the optional substituent is one or more heteroatom; an optionally substituted alkenyl group having from 2 to 20 carbon atoms, where the optional substituents is one or more heteroatom; an optionally substituted cycloalkyl group having from 3 to 10 carbon atoms, where the optional substituent is one or more heteroatom; an optionally substituted aryl group having from 6 to 12 carbon atoms, where the optional substituent is one or more heteroatom; or an optionally substituted aralkyl group having from 7 to 16 carbon atoms, where the optional substituent is one or more heteroatom;
L is an optionally substituted alkylene group having from 1 to 20 carbon atoms, where the optional substituent is one or more heteroatom; an optionally substituted alkenylene group having from 2 to 20 carbon atoms, where the optional substituent is one or more heteroatom; an optionally substituted cycloalkylene group having from 3 to 10 carbon atoms, where the optional substituent is one or more heteroatom; an optionally substituted arylene group having from 6 to 12 carbon atoms, where the optional substituent is one or more heteroatom; or an optionally substituted aralkylene group having from 7 to 16 carbon atoms, where the optional substituent is one or more heteroatom;
R³ is an optionally substituted alkyl group having from 1 to 20 carbon atoms, where the optional substituent is one or more heteroatom; an optionally substituted alkenyl group having from 2 to 20 carbon atoms, where the optional substituent is one or more heteroatom; an optionally substituted cycloalkyl group having from 3 to 10 carbon atoms, where the optional substituent is one or more heteroatom; an optionally substituted aryl group having from 6 to 12 carbon atoms, where the optional substituent is one or more heteroatom; or an optionally substituted aralkyl group having from 7 to 16 carbon atoms, where the optional substituent is one or more heteroatom;
each R⁴ independently is an optionally substituted alkyl group having from 6 to 30 carbon atoms, where the optional substituent is one or more heteroatom; an optionally substituted alkenyl group having from 6 to 30 carbon atoms, where the optional substituent is one or more heteroatom; an optionally substituted alkynyl group having from 6 to 30 carbon atoms, where the optional substituent is one or more heteroatom; an optionally substituted cycloalkyl group having from 3 to 10 carbon atoms, where the optional substituent is one or more heteroatom; an optionally substituted aryl group having from 6 to 12 carbon atoms, where the optional substituent is one or more heteroatom; an optionally substituted aralkyl group having from 7 to 20 carbon atoms, where the optional substituent is one or more heteroatom; or an optionally substituted cyclic silane; or
R⁴ is R²³, where each R²³ independently is an optionally substituted straight chain or branched chain alkyl group, having from 1 to 10 carbon atoms, where two R²³ combine with each other to form a ring together with the —O—Si—O— atoms to which they are bonded, and where the optional substituent is one or more heteroatom, and wherein the two R²³ can be the same or different; or
each R⁴ independently is a group represented by —(R⁵—O)ₘ—R⁶, where each R⁵ is the same as or different from each other and each represents a branched or unbranched C₁-C₃₀ divalent hydrocarbon group; R⁶ represents a branched or unbranched C₁-C₃₀ alkyl group, a branched or unbranched C₂-C₃₀ alkenyl group, a C₆-C₃₀ aryl group, or a C₇-C₃₀ aralkyl group; and m is an integer of 1 to 30;
b is 2 or 3;
c is 1 or 2, with the proviso that c is less than or equal to d; and
d is 1, 2, or 3.

In some aspects, R¹ is a C₁-C₂₀ alkyl. In some aspects, R¹ is a C₁-C₁₀ alkyl. In some aspects, R¹ is a C₁-C₅ alkyl. In some aspects, R¹ is a C₄ alkyl. In some aspects, R¹ is —CH₂CH(CH₃)₂.

In some aspects, R² is an optionally substituted alkyl group having from 1 to 20 carbon atoms, where the optional substituent is one or more heteroatom. In some aspects, the heteroatom is N, O, or S.

In some aspects, R² is a C₁-C₂₀ alkyl. In some aspects, R² is a C₁-C₁₀ alkyl. In some aspects, R² is a C₁-C₅ alkyl. In some aspects, R² is methyl.

In some aspects, L is an optionally substituted alkyl group having from 1 to 20 carbon atoms, where the optional substituent is one or more heteroatom. In some aspects, the heteroatom is N, O, or S.

In some aspects, L is a C₁-C₁₂ alkylene. In some aspects, L is a C₁-C₅ alkylene. In some aspects, L is a C₁-C₄ alkylene. In some aspects, L is a C₃ alkylene. In some aspects, L is —CH₂CH₂CH₂—.

In some aspects, R³ is an optionally substituted alkyl group having from 1 to 20 carbon atoms, where the optional substituent is one or more heteroatom. In some aspects, the heteroatom is N, O, or S.

In some aspects, R³ is a C₁-C₂₀ alkyl. In some aspects, R³ is a C₁-C₁₀ alkyl. In some aspects, R³ is a C₁-C₅ alkyl. In some aspects, R³ is methyl.

In some aspects, each R⁴ is different. In some aspects, two R⁴ groups are the same. In some aspects, three R⁴ groups are the same.

In some aspects, at least one R⁴ is an optionally substituted aralkyl group having from 7 to 20 carbon atoms, where the optional substituent is one or more heteroatom. In some aspects, the heteroatom is N, O, or S.

In some aspects, one R⁴ is an optionally substituted aralkyl group having from 7 to 20 carbon atoms, where the optional substituent is one or more heteroatom, and wherein the heteroatom is N, O, or S. In some aspects, two R⁴ are an optionally substituted aralkyl group having from 7 to 20 carbon atoms, where the optional substituent is one or more heteroatom, and wherein the heteroatom is N, O, or S. In some aspects, three R⁴ are an optionally substituted aralkyl group having from 7 to 20 carbon atoms, where the optional substituent is one or more heteroatom, and wherein the heteroatom is N, O, or S.

In some aspects, at least one R⁴ is an optionally substituted aralkyl group having from 7 to 20 carbon atoms.

In some aspects, one R⁴ is an optionally substituted aralkyl group having from 7 to 20 carbon atoms. In some aspects, two R⁴ are an optionally substituted aralkyl group having from 7 to 20 carbon atoms. In some aspects, three R⁴ are an optionally substituted aralkyl group having from 7 to 20 carbon atoms.

In some aspects, two R⁴ are a C₇-C₂₀ aralkyl. In some aspects, two R⁴ are

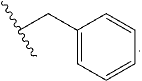 [SMILES: *Cc1ccccc1]

In some aspects, two R⁴ combine with each other to form a ring comprising an optionally substituted —(C₂-C₁₀ alkyl)— group together with the —O—Si—O— atoms to which they are bonded. In some aspects, two R⁴ combine with each other to form a ring comprising an optionally substituted —(C₂-C₈ alkyl)— group together with the —O—Si—O— atoms to which they are bonded. In some aspects, two R⁴ combine with each other to form a ring comprising an optionally substituted —(C₂-C₄ alkyl)— group together with the —O—Si—O— atoms to which they are bonded. In some aspects, two R⁴ combine with each other to form a ring comprising —CH₂CH₂CH(CH₃)— together with the —O—Si—O— atoms to which they are bonded.

In some aspects, R⁴ can be —(R⁵—O)ₘ—R⁶, in which each R⁵ is the same as or different from each other and each is a branched or unbranched C₁-C₃₀ divalent hydrocarbon group; R⁶ is a branched or unbranched C₁-C₃₀ alkyl group, a branched or unbranched C₂-C₃₀ alkenyl group, a C₆-C₃₀ aryl group, or a C₇-C₃₀ aralkyl group; and m is an integer of 1 to 30.

In some aspects, R⁵ is the same as or different from each other and each is a branched or unbranched C₁-C₁₀ divalent hydrocarbon group. In some aspects, R⁵ is the same as or different from each other and each is a branched or unbranched C₁-C₃ divalent hydrocarbon group.

In some aspects, the hydrocarbon group of R⁵ can be branched or unbranched C₁-C₃₀ alkylene, branched or unbranched C₂-C₃₀ alkenylene groups, branched or unbranched C₁-C₃₀ alkynylene groups, and C₆-C₃₀ arylene groups.

In some aspects, the branched or unbranched C₁-C₃₀ alkylene groups of R⁵ can be methylene, ethylene, propylene, butylene, pentylene, hexylene, heptylene, octylene, nonylene, decylene, undecylene, dodecylene, tridecylene, tetradecylene, pentadecylene, hexadecylene, heptadecylene, and octadecylene groups.

In some aspects, the branched or unbranched C₂-C₃₀ alkenylene groups of R⁵ can be vinylene, 1-propenylene, 2-propenylene, 1-butenylene, 2-butenylene, 1-pentenylene, 2-pentenylene, 1-hexenylene, 2-hexenylene, and 1-octenylene groups.

In some aspects, the branched or unbranched C₂-C₃₀ alkynylene groups of R⁵ can be ethynylene, propynylene, butynylene, pentynylene, hexynylene, heptynylene, octynylene, nonynylene, decynylene, undecynylene, and dodecynylene groups.

In some aspects, the C₆-C₃₀ arylene groups of R⁵ can be phenylene, tolylene, xylylene, and naphthylene groups.

In some aspects, R⁶ represents a branched or unbranched C₁-C₃₀ alkyl group, a branched or unbranched C₂-C₃₀ alkenyl group, a C₆-C₃₀ aryl group, or a C₇-C₃₀ aralkyl group.

In some aspects, the branched or unbranched C₁-C₃₀ alkyl groups of R⁶ can be methyl, ethyl, n-propyl, isopropyl, n-butyl, iso-butyl, sec-butyl, tert-butyl, pentyl, hexyl, heptyl, 2-ethylhexyl, octyl, nonyl, decyl, undecyl, dodecyl, tridecyl, tetradecyl, pentadecyl, and octadecyl groups.

In some aspects, the branched or unbranched C₂-C₃₀ alkenyl groups of R⁶ can be vinyl, 1-propenyl, 2-propenyl, 1-butenyl, 2-butenyl, 1-pentenyl, 2-pentenyl, 1-hexenyl, 2-hexenyl, 1-octenyl, decenyl, undecenyl, dodecenyl, tridecenyl, tetradecenyl, pentadecenyl, and octadecenyl groups.

In some aspects, the C₆-C₃₀ aryl groups of R⁶ can be phenyl, tolyl, xylyl, naphthyl, and biphenyl groups.

In some aspects, the C₇-C₃₀ aralkyl groups of R⁶ can be benzyl and phenethyl groups.

In some aspects, —(R⁵—O)ₘ—R⁶ can be —O—(C₂H₄—O)₅—C₁₁H₂₃, —O—(C₂H₄—O)₅—C₁₂H₂₅, —O—(C₂H₄—O)₅—C₁₃H₂₇, —O—(C₂H₄—O)₅—C₁₄H₂₉, —O—(C₂H₄—O)₅—C₁₅H₃₁, —O—(C₂H₄—O)₃—C₁₃H₂₇, —O—(C₂H₄—O)₄—C₁₃H₂₇, —O—(C₂H₄—O)₆—C₁₃H₂₇, and —O—(C₂H₄—O)₇—C₁₃H₂₇. In some aspects, —(R⁵—O)ₘ—R⁶ can be —O—(C₂H₄—O)₅—C₁₁H₂₃, —O—(C₂H₄—O)₅—C₁₃H₂₇, —O—(C₂H₄—O)₅—C₁₅H₃₁, and —O—(C₂H₄—O)₆—C₁₃H₂₇.

In some aspects, m represents an integer of 1 to 30. In some aspects, m represents an integer of 2 to 20. In some aspects, m represents an integer of 5 to 6.

In some aspects, b is 2. In some aspects, b is 3.

In some aspects, c is 1. In some aspects, c is 2.

In some aspects, d is 1. In some aspects, dis 2. In some aspects, d is 3.

In some aspects, each G is styrene butadiene polymer.

In some aspects, G is a polymer fragment of Formula (III)

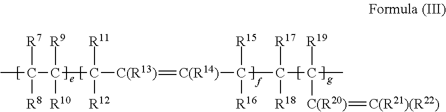

wherein
each R⁷, R⁸, R⁹, R¹¹, R¹², R¹³, R¹⁴, R¹⁵, R¹⁶, R¹⁷, R¹⁸, R¹⁹, R²⁰, R²¹, and R²² independently is hydrogen or an alkyl group having from 1 to 20 carbon atoms;
each R¹⁰ independently is hydrogen, an alkyl group having from 1 to 20 carbon atoms and optionally at least one heteroatom, an alkenyl group having from 2 to 20 carbon atoms, a cycloalkyl group having from 3 to 14 carbon atoms, a cycloalkenyl group having from 4 to 14 carbon atoms, an aryl group having from 6 to 16 carbon atoms, or an aralkyl group having from 7 to 20 carbon atoms; and
f, g and h are integers, wherein f is equal to or greater than 0, g is equal to or greater than 0, and h is equal to or greater than 0, with the proviso that the sum of f, g and h is equal to or greater than 1.

In some aspects, f is from 0 to 10,000. In some aspects, f is from 1 to 5,000. In some aspects, f is from 100 to 2,500.

In some aspects, g is from 0 to 10,000. In some aspects, g is from 0 to 5,000. In some aspects, g is from 100 to 2,500.

In some aspects, h is from 0 to 10,000. In some aspects, h is from 0 to 5,000. In some aspects, h is from 100 to 2,500.

In some aspects, the sum of f, g and h is from 100 to 5,000.

In some aspects, the anionic initiator is n-butyllithium.

In some aspects, the ratio between the anionic initiator and the monomers is from about 1:1 to about 1:10,000, from about 1:10 to about 1:9,000, from about 1:50 to about 1:8,000, from about 1:100 to about 1:7,000, from about 1:200 to about 1:6,000, from about 1:300 to about 1:5,000, from about 1:400 to about 1:4,000, from about 1:500 to about 1:3,000, from about 1:600 to about 1:2,000, from about 1:700 to about 1:1,000, and from about 1:800 to about 1:900.

In some aspects, ratio between the anionic initiator and the silane compound of formula (I) is from about 10:1 to about 1:1, from about 9:1 to about 1:1, from about 8:1 to about 1:1, from about 6:1 to about 1:1, from about 5:1 to about 1:1, from about 4:1 to about 1:1, and from about 3:1 to about 1:1. In some aspects, the ratio between the anionic initiator and the silane compound of formula (I) is about 2:1. In some aspects, the ratio between the anionic initiator and the silane compound of formula (I) is about 1:1.

In some aspects, wherein
(a) when L is —CH₂CH₂CH₂—, the polymer of formula (II) is

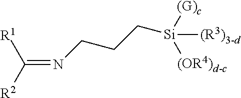

and is prepared by reacting the polymer fragment G with the silane compound of Formula (I) which is

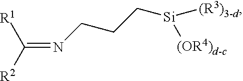

or
(b) when R¹ is —CH₂CH(CH₃)₂ and R² is —CH₃, the polymer of Formula (II) is

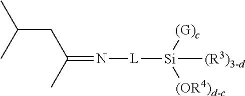

and is prepared by reacting the polymer fragment G with the silane compound of Formula (I) which is

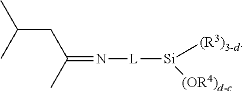

In some aspects, the present disclosure provides a method of making a polymer represented by Formula (IV)

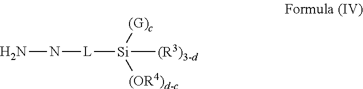

comprising reacting a polymer represented by Formula (II)

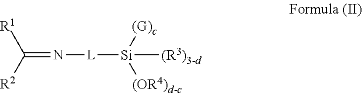

with water,
wherein
each R¹ and R² independently is hydrogen; an optionally substituted alkyl group having from 1 to 20 carbon atoms, where the optional substituent is one or more heteroatom; an optionally substituted alkenyl group having from 2 to 20 carbon atoms, where the optional substituents is one or more heteroatom; an optionally substituted cycloalkyl group having from 3 to 10 carbon atoms, where the optional substituent is one or more heteroatom; an optionally substituted aryl group having from 6 to 12 carbon atoms, where the optional substituent is one or more heteroatom; or an optionally substituted aralkyl group having from 7 to 16 carbon atoms, where the optional substituent is one or more heteroatom;
L is an optionally substituted alkylene group having from 1 to 20 carbon atoms, where the optional substituent is one or more heteroatom; an optionally substituted alkenylene group having from 2 to 20 carbon atoms, where the optional substituent is one or more heteroatom; an optionally substituted cycloalkylene group having from 3 to 10 carbon atoms, where the optional substituent is one or more heteroatom; an optionally substituted arylene group having from 6 to 12 carbon atoms, where the optional substituent is one or more heteroatom; or an optionally substituted aralkylene group having from 7 to 16 carbon atoms, where the optional substituent is one or more heteroatom;
R³ is an optionally substituted alkyl group having from 1 to 20 carbon atoms, where the optional substituent is one or more heteroatom; an optionally substituted alkenyl group having from 2 to 20 carbon atoms, where the optional substituent is one or more heteroatom; an optionally substituted cycloalkyl group having from 3 to 10 carbon atoms, where the optional substituent is one or more heteroatom; an optionally substituted aryl group having from 6 to 12 carbon atoms, where the optional substituent is one or more heteroatom; or an optionally substituted aralkyl group having from 7 to 16 carbon atoms, where the optional substituent is one or more heteroatom;
each R⁴ independently is an optionally substituted alkyl group having from 6 to 30 carbon atoms, where the optional substituent is one or more heteroatom; an optionally substituted alkenyl group having from 6 to 30 carbon atoms, where the optional substituent is one or more heteroatom; an optionally substituted alkynyl group having from 6 to 30 carbon atoms, where the optional substituent is one or more heteroatom; an optionally substituted cycloalkyl group having from 3 to 10 carbon atoms, where the optional substituent is one or more heteroatom; an optionally substituted aryl group having from 6 to 12 carbon atoms, where the optional substituent is one or more heteroatom; an optionally substituted aralkyl group having from 7 to 20 carbon atoms, where the optional substituent is one or more heteroatom; or an optionally substituted cyclic silane; or
R⁴ is R²³, where each R²³ independently is an optionally substituted straight chain or branched chain alkyl group, having from 1 to 10 carbon atoms, where two R²³ combine with each other to form a ring together with the —O—Si—O— atoms to which they are bonded, and where the optional substituent is one or more heteroatom, and wherein the two R²³ can be the same or different; or
each R⁴ independently is a group represented by —(R⁵—O)ₘ—R⁶, where each R⁵ is the same as or different from each other and each represents a branched or unbranched C₁-C₃₀ divalent hydrocarbon group; R⁶ represents a branched or unbranched C₁-C₃₀ alkyl group, a branched or unbranched C₂-C₃₀ alkenyl group, a C₆-C₃₀ aryl group, or a C₇-C₃₀ aralkyl group; and m is an integer of 1 to 30;
c is 1 or 2, with the proviso that c is equal to or less than d;
d is 2 or 3; and
each G is independently a polymer fragment having a backbone of carbon atoms covalently bonded together by C—C single bond, C═C double bond, or a combination of C—C single bonds and C═C double bonds.

In some aspects, R¹ is a C₁-C₂₀ alkyl. In some aspects, R¹ is a C₁-C₁₀ alkyl. In some aspects, R¹ is a C₁-C₅ alkyl. In some aspects, R¹ is a C₄ alkyl. In some aspects, R¹ is —CH₂CH(CH₃)₂.

In some aspects, R² is an optionally substituted alkyl group having from 1 to 20 carbon atoms, where the optional substituent is one or more heteroatom. In some aspects, the heteroatom is N, O, or S.

In some aspects, R² is a C₁-C₂₀ alkyl. In some aspects, R² is a C₁-C₁₀ alkyl. In some aspects, R² is a C₁-C₅ alkyl. In some aspects, R² is methyl.

In some aspects, L is an optionally substituted alkyl group having from 1 to 20 carbon atoms, where the optional substituent is one or more heteroatom. In some aspects, the heteroatom is N, O, or S.

In some aspects, L is a C₁-C₁₂ alkylene. In some aspects, L is a C₁-C₈ alkylene. In some aspects, L is a C₁-C₄ alkylene. In some aspects, L is a C₃ alkylene. In some aspects, L is —CH₂CH₂CH₂—.

In some aspects, R³ is an optionally substituted alkyl group having from 1 to 20 carbon atoms, where the optional substituent is one or more heteroatom. In some aspects, the heteroatom is N, O, or S.

In some aspects, R³ is a C₁-C₂₀ alkyl. In some aspects, R³ is a C₁-C₁₀ alkyl. In some aspects, R³ is a C₁-C₅ alkyl. In some aspects, R³ is methyl.

In some aspects, each R⁴ is different. In some aspects, two R⁴ groups are the same. In some aspects, three R⁴ groups are the same.

In some aspects, at least one R⁴ is an optionally substituted aralkyl group having from 7 to 20 carbon atoms, where the optional substituent is one or more heteroatom. In some aspects, the heteroatom is N, O, or S.

In some aspects, one R⁴ is an optionally substituted aralkyl group having from 7 to 20 carbon atoms, where the optional substituent is one or more heteroatom, and wherein the heteroatom is N, O, or S. In some aspects, two R⁴ are an optionally substituted aralkyl group having from 7 to 20 carbon atoms, where the optional substituent is one or more heteroatom, and wherein the heteroatom is N, O, or S. In some aspects, three R⁴ are an optionally substituted aralkyl group having from 7 to 20 carbon atoms, where the optional substituent is one or more heteroatom, and wherein the heteroatom is N, O, or S.

In some aspects, at least one R⁴ is an optionally substituted aralkyl group having from 7 to 20 carbon atoms.

In some aspects, one R⁴ is an optionally substituted aralkyl group having from 7 to 20 carbon atoms. In some aspects, two R⁴ are an optionally substituted aralkyl group having from 7 to 20 carbon atoms. In some aspects, three R⁴ are an optionally substituted aralkyl group having from 7 to 20 carbon atoms.

In some aspects, two R⁴ are a C₇-C₂₀ aralkyl. In some aspects, two R⁴ are

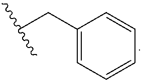 [SMILES: *Cc1ccccc1]

In some aspects, two R⁴ combine with each other to form a ring comprising an optionally substituted —(C₂-C₁₀ alkyl)— group together with the —O—Si—O— atoms to which they are bonded. In some aspects, two R⁴ combine with each other to form a ring comprising an optionally substituted —(C₂-C₈ alkyl)— group together with the —O—Si—O— atoms to which they are bonded. In some aspects, two R⁴ combine with each other to form a ring comprising an optionally substituted —(C₂-C₄ alkyl)— group together with the —O—Si—O— atoms to which they are bonded. In some aspects, two R⁴ combine with each other to form a ring comprising —CH₂CH₂CH(CH₃)— together with the —O—Si—O— atoms to which they are bonded.

In some aspects, R⁴ can be —(R⁵—O)ₘ—R⁶, in which each R⁵ is the same as or different from each other and each is a branched or unbranched C₁-C₃₀ divalent hydrocarbon group; R⁶ is a branched or unbranched C₁-C₃₀ alkyl group, a branched or unbranched C₂-C₃₀ alkenyl group, a C₆-C₃₀ aryl group, or a C₇-C₃₀ aralkyl group; and m is an integer of 1 to 30.

In some aspects, R⁵ is the same as or different from each other and each is a branched or unbranched C₁-C₁₀ divalent hydrocarbon group. In some aspects, R⁵ is the same as or different from each other and each is a branched or unbranched C₁-C₃ divalent hydrocarbon group.

In some aspects, the hydrocarbon group of R⁵ can be branched or unbranched C₁-C₃₀ alkylene, branched or unbranched C₂-C₃₀ alkenylene groups, branched or unbranched C₂-C₃₀ alkynylene groups, and C₆-C₃₀ arylene groups.

In some aspects, the branched or unbranched C₁-C₃₀ alkylene groups of R⁵ can be methylene, ethylene, propylene, butylene, pentylene, hexylene, heptylene, octylene, nonylene, decylene, undecylene, dodecylene, tridecylene, tetradecylene, pentadecylene, hexadecylene, heptadecylene, and octadecylene groups.

In some aspects, the branched or unbranched C₂-C₃₀ alkenylene groups of R⁵ can be vinylene, 1-propenylene, 2-propenylene, 1-butenylene, 2-butenylene, 1-pentenylene, 2-pentenylene, 1-hexenylene, 2-hexenylene, and 1-octenylene groups.

In some aspects, the branched or unbranched C₂-C₃₀ alkynylene groups of R⁵ can be ethynylene, propynylene, butynylene, pentynylene, hexynylene, heptynylene, octynylene, nonynylene, decynylene, undecynylene, and dodecynylene groups.

In some aspects, the C₆-C₃₀ arylene groups of R⁵ can be phenylene, tolylene, xylylene, and naphthylene groups.

In some aspects, m represents an integer of 1 to 30. In some aspects, m represents an integer of 2 to 20. In some aspects, m represents an integer of 5 to 6.

In some aspects, R⁶ represents a branched or unbranched C₁-C₃₀ alkyl group, a branched or unbranched C₂-C₃₀ alkenyl group, a C₆-C₃₀ aryl group, or a C₇-C₃₀ aralkyl group.

In some aspects, the branched or unbranched C₁-C₃₀ alkyl groups of R⁶ can be methyl, ethyl, n-propyl, isopropyl, n-butyl, iso-butyl, sec-butyl, tert-butyl, pentyl, hexyl, heptyl, 2-ethylhexyl, octyl, nonyl, decyl, undecyl, dodecyl, tridecyl, tetradecyl, pentadecyl, and octadecyl groups.

In some aspects, the branched or unbranched C₂-C₃₀ alkenyl groups of R⁶ can be vinyl, 1-propenyl, 2-propenyl, 1-butenyl, 2-butenyl, 1-pentenyl, 2-pentenyl, 1-hexenyl, 2-hexenyl, 1-octenyl, decenyl, undecenyl, dodecenyl, tridecenyl, tetradecenyl, pentadecenyl, and octadecenyl groups.

In some aspects, the C₆-C₃₀ aryl groups of R⁶ can be phenyl, tolyl, xylyl, naphthyl, and biphenyl groups.

In some aspects, the C₇-C₃₀ aralkyl groups of R⁶ can be benzyl and phenethyl groups.

In some aspects, —(R⁵—O)ₘ—R⁶ can be —O—(C₂H₄—O)₅—C₁₁H₂₃, —O—(C₂H₄—O)₅—C₁₂H₂₅, —O—(C₂H₄—O)₅—C₁₃H₂₇, —O—(C₂H₄—O)₅—C₁₄H₂₉, —O—(C₂H₄—O)₅—C₁₅H₃₁, —O—(C₂H₄—O)₃—C₁₃H₂₇, —O—(C₂H₄—O)₄—C₁₃H₂₇, —O—(C₂H₄—O)₆—C₁₃H₂₇, and —O—(C₂H₄—O)₇—C₁₃H₂₇. In some aspects, —(R⁵—O)ₘ—R⁶ can be —O—(C₂H₄—O)₅—C₁₁H₂₃, —O—(C₂H₄—O)₅—C₁₃H₂₇, —O—(C₂H₄—O)₅—C₁₅H₃₁, and —O—(C₂H₄—O)₆—C₁₃H₂₇.

In some aspects, c is 1. In some aspects, c is 2.

In some aspects, d is 1. In some aspects, dis 2. In some aspects, d is 3.

In some aspects, each G is styrene butadiene polymer.

In some aspects, G is a polymer fragment of Formula (III)

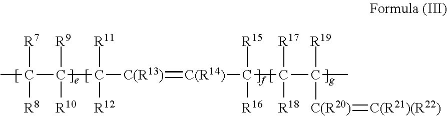

wherein
each R⁷, R⁸, R⁹, R¹¹, R¹², R¹³, R¹⁴, R¹⁵, R¹⁶, R¹⁷, R¹⁸, R¹⁹, R²⁰, R²¹, and R²² independently is hydrogen or an alkyl group having from 1 to 20 carbon atoms;
each R¹⁰ independently is hydrogen, an alkyl group having from 1 to 20 carbon atoms and optionally at least one heteroatom, an alkenyl group having from 2 to 20 carbon atoms, a cycloalkyl group having from 3 to 14 carbon atoms, a cycloalkenyl group having from 4 to 14 carbon atoms, an aryl group having from 6 to 16 carbon atoms, or an aralkyl group having from 7 to 20 carbon atoms; and
f, g and h are integers, wherein f is equal to or greater than 0, g is equal to or greater than 0, and h is equal to or greater than 0, with the proviso that the sum of f, g and h is equal to or greater than 1.

In some aspects, f is from 0 to 10,000. In some aspects, f is from 1 to 5,000. In some aspects, f is from 100 to 2,500.

In some aspects, g is from 0 to 10,000. In some aspects, g is from 0 to 5,000. In some aspects, g is from 100 to 2,500.

In some aspects, h is from 0 to 10,000. In some aspects, h is from 0 to 5,000. In some aspects, h is from 100 to 2,500.

In some aspects, the sum of f, g and h is from 100 to 5,000.

### VI. Silane Compositions and Rubber Compositions

The disclosure relates to a composition comprising one or more polymers described above. The disclosure further relates to a composition comprising one or more polymers prepared by the methods described above.

The disclosure provides a rubber composition comprising the composition described above.

The disclosure further provides a rubber composition comprising:
(i) about 100 parts of rubber, where the weight of the rubber is the sum of the weights of each (a) diene-based polymer containing at least one functional group or (b) diene-based polymer containing no functional group;
(ii) about 5 to about 140 parts by weight per 100 parts rubber (i) of silica;
(iii) about 0.1 to about 20 parts by weight per 100 parts rubber (i) of diene-based polymer containing at least one functional group;
(iv) about 0.1 to about 10 parts by weight per 100 parts rubber (i) of at least one process aid; and
(v) about 0.1 to about 20 parts by weight per 100 parts rubber (i) of a vulcanization package comprising at least one vulcanizing agent comprising sulfur and at least one accelerator.

In some aspects, the rubber composition comprises (ii) about 5 to about 140 parts by weight per 100 parts rubber (i) of silica, about 5 to about 100 parts by weight per 100 parts rubber (i) of silica, about 5 to about 60 parts by weight per 100 parts rubber (i) of silica, about 5 to about 20 parts by weight per 100 parts rubber (i) of silica, about 20 to about 140 parts by weight per 100 parts rubber (i) of silica, about 20 to about 100 parts by weight per 100 parts rubber (i) of silica, about 20 to about 60 parts by weight per 100 parts rubber (i) of silica, about 60 to about 140 parts by weight per 100 parts rubber (i) of silica, about 60 to about 100 parts by weight per 100 parts rubber (i) of silica, or about 100 to about 140 parts by weight per 100 parts rubber (i) of silica.

In some aspects, the rubber composition comprises (iii) about 0.1 to about 20 parts by weight per 100 parts rubber (i) of diene-based polymer containing at least one functional group, about 0.1 to about 10 parts by weight per 100 parts rubber (i) of diene-based polymer containing at least one functional group, about 0.1 to about 5 parts by weight per 100 parts rubber (i) of diene-based polymer containing at least one functional group, about 0.1 to about 1 part by weight per 100 parts rubber (i) of diene-based polymer containing at least one functional group, about 1 to about 20 parts by weight per 100 parts rubber (i) of diene-based polymer containing at least one functional group, about 1 to about 10 parts by weight per 100 parts rubber (i) of diene-based polymer containing at least one functional group, about 1 to about 5 parts by weight per 100 parts rubber (i) of diene-based polymer containing at least one functional group, about 5 to about 20 parts by weight per 100 parts rubber (i) of diene-based polymer containing at least one functional group, about 5 to about 10 parts by weight per 100 parts rubber (i) of diene-based polymer containing at least one functional group, or about 10 to about 20 parts by weight per 100 parts rubber (i) of diene-based polymer containing at least one functional group.

In some aspects, the rubber composition comprises (iv) about 0.1 to about 10 parts by weight per 100 parts rubber (i) of at least one process aid, about 0.1 to about 5 parts by weight per 100 parts rubber (i) of at least one process aid, about 0.1 to about 2.5 parts by weight per 100 parts rubber (i) of at least one process aid, about 0.1 to about 1 part by weight per 100 parts rubber (i) of at least one process aid, about 1 to about 10 parts by weight per 100 parts rubber (i) of at least one process aid, about 1 to about 5 parts by weight per 100 parts rubber (i) of at least one process aid, about 1 to about 2.5 parts by weight per 100 parts rubber (i) of at least one process aid, about 2.5 to about 10 parts by weight per 100 parts rubber (i) of at least one process aid, about 2.5 to about 5 parts by weight per 100 parts rubber (i) of at least one process aid, or about 5 to about 10 parts by weight per 100 parts rubber (i) of at least one process aid.

In some aspects, the rubber composition comprises (v) about 0.1 to about 20 parts by weight per 100 parts rubber (i) of a vulcanization package comprising at least one vulcanizing agent comprising sulfur and at least one accelerator, about 0.1 to about 10 parts by weight per 100 parts rubber (i) of a vulcanization package comprising at least one vulcanizing agent comprising sulfur and at least one accelerator, about 0.1 to about 5 parts by weight per 100 parts rubber (i) of a vulcanization package comprising at least one vulcanizing agent comprising sulfur and at least one accelerator, about 0.1 to about 1 part by weight per 100 parts rubber (i) of a vulcanization package comprising at least one vulcanizing agent comprising sulfur and at least one accelerator, about 1 to about 20 parts by weight per 100 parts rubber (i) of a vulcanization package comprising at least one vulcanizing agent comprising sulfur and at least one accelerator, about 1 to about 10 parts by weight per 100 parts rubber (i) of a vulcanization package comprising at least one vulcanizing agent comprising sulfur and at least one accelerator, about 1 to about 5 parts by weight per 100 parts rubber (i) of a vulcanization package comprising at least one vulcanizing agent comprising sulfur and at least one accelerator, about 5 to about 20 parts by weight per 100 parts rubber (i) of a vulcanization package comprising at least one vulcanizing agent comprising sulfur and at least one accelerator, about 5 to about 10 parts by weight per 100 parts rubber (i) of a vulcanization package comprising at least one vulcanizing agent comprising sulfur and at least one accelerator, or about 10 to about 20 parts by weight per 100 parts rubber (i) of a vulcanization package comprising at least one vulcanizing agent comprising sulfur and at least one accelerator.

The abbreviation “phr” refers to the units for the parts by weight per 100 parts rubber.

In some aspects, the diene-based polymer is a diene-based polymer containing at least one functional group, a diene-based polymer containing no functional group, or combinations thereof.

In some aspects, the diene-based polymer is natural rubber, styrene-butadiene rubber, cis 1,4-polyisoprene, cis 1,4-polybutadiene, trans 1,4-polybutadiene, 1,2-polybutadiene, or combinations thereof.

In some aspects, the process aid is 2,2,4-trimethyl-1,2-dihydroquinoline, N-(1,3-dimethylbutyl)-N′-phenyl-p-phenylenediamine, octyl triethoxysilane, a triethoxysilylated hydrocarbon, zinc stearate, steric acid, zinc soaps of fatty acids, paraffin wax, microcrystalline wax, paraffinic process oil, naphthenic process oil, aromatic process oil, or combinations thereof.

In some aspects, the sulfur in the vulcanizing agent is selected from the group consisting of elemental sulfur, sulfur-donating compounds, and combinations thereof.

In some aspects, the accelerator is selected from the group consisting of benzothiazoles, guanidine derivatives, thiocarbamates, and combinations thereof.

In some aspects, the accelerator is selected from the group consisting of mercapto benzothiazole, benzothiazole disulfide, diphenylguanidine, zinc dithiocarbamate, alkylphenoldisulfide, zinc butyl xanthate, N-dicyclohexyl-2-benzothiazolesulfenamide, N-cyclohexyl-2-benzothiazolesulfenamide, N-oxydiethylenebenzothiazole-2-sulfenamide, N,N-diphenylthiourea, dithiocarbamylsulfenamide, N,N-diisopropylbenzothiozole-2-sulfenamide, zinc-2-mercaptotoluimidazole, dithiobis(N-methyl piperazine), dithiobis(N-beta-hydroxy ethyl piperazine), dithiobis(dibenzyl amine), and combinations thereof.

In some aspects, the rubber composition further comprises at least one filler from about 0.1 to about 20 parts by weight per 100 parts rubber. In some aspects, the rubber composition comprises about 0.1 to about 20 parts by weight per 100 parts rubber of at least one filler, about 0.1 to about 10 parts by weight per 100 parts rubber of at least one filler, about 0.1 to about 5 parts by weight per 100 parts rubber of at least one filler, about 0.1 to about 1 part by weight per 100 parts rubber of at least one filler, about 1 to about 20 parts by weight per 100 parts rubber of at least one filler, about 1 to about 10 parts by weight per 100 parts rubber of at least one filler, about 1 to about 5 parts by weight per 100 parts rubber of at least one filler, about 5 to about 20 parts by weight per 100 parts rubber of at least one filler, about 5 to about 10 parts by weight per 100 parts rubber of at least one filler, or about 10 to about 20 parts by weight per 100 parts rubber of at least one filler.

In some aspects, the filler is selected from the group consisting of titanium dioxide, alumina, aluminosilicates, siliceous materials, carbon black, acetylene black, calcium carbonate, barium sulfate, and combinations thereof.

In some aspects, the rubber composition further comprises at least one process oil from about 0.1 to about 20 parts by weight per 100 parts rubber. In some aspects, the process oil is treated distillate aromatic extracted (TDAE) oil. In some aspects, the rubber composition comprises about 0.1 to about 20 parts by weight per 100 parts rubber of at least one process oil, about 0.1 to about 10 parts by weight per 100 parts rubber of at least one process oil, about 0.1 to about 5 parts by weight per 100 parts rubber of at least one process oil, about 0.1 to about 1 part by weight per 100 parts rubber of at least one process oil, about 1 to about 20 parts by weight per 100 parts rubber of at least one process oil, about 1 to about 10 parts by weight per 100 parts rubber of at least one process oil, about 1 to about 5 parts by weight per 100 parts rubber of at least one process oil, about 5 to about 20 parts by weight per 100 parts rubber of at least one process oil, about 5 to about 10 parts by weight per 100 parts rubber of at least one process oil, or about 10 to about 20 parts by weight per 100 parts rubber of at least one process oil.

In some aspects, the rubber composition further comprises at least one activator from about 0.1 to about 20 parts by weight per 100 parts rubber. In some aspects, the activator is zinc oxide or stearic acid. In some aspects, the rubber composition comprises about 0.1 to about 20 parts by weight per 100 parts rubber of at least one activator, about 0.1 to about 10 parts by weight per 100 parts rubber of at least one activator, about 0.1 to about 5 parts by weight per 100 parts rubber of at least one activator, about 0.1 to about 1 part by weight per 100 parts rubber of at least one activator, about 1 to about 20 parts by weight per 100 parts rubber of at least one activator, about 1 to about 10 parts by weight per 100 parts rubber of at least one activator, about 1 to about 5 parts by weight per 100 parts rubber of at least one activator, about 5 to about 20 parts by weight per 100 parts rubber of at least one activator, about 5 to about 10 parts by weight per 100 parts rubber of at least one activator, or about 10 to about 20 parts by weight per 100 parts rubber of at least one activator.

In some aspects, the rubber composition further comprises at least one antidegradant from about 0.1 to about 20 parts by weight per 100 parts rubber. In some aspects, the antidegradant is N-(1,3-dimethylbutyl)-N′-phenyl-p-phenylenediamine. In some aspects, the antidegradant is 2,2,4-trimethyl-1,2-dihydroquinoline polymer or a microcrystalline wax. In some aspects, the rubber composition comprises about 0.1 to about 20 parts by weight per 100 parts rubber of at least one antidegradant, about 0.1 to about 10 parts by weight per 100 parts rubber of at least one antidegradant, about 0.1 to about 5 parts by weight per 100 parts rubber of at least one antidegradant, about 0.1 to about 1 part by weight per 100 parts rubber of at least one activator, about 1 to about 20 parts by weight per 100 parts rubber of at least one antidegradant, about 1 to about 10 parts by weight per 100 parts rubber of at least one antidegradant, about 1 to about 5 parts by weight per 100 parts rubber of at least one antidegradant, about 5 to about 20 parts by weight per 100 parts rubber of at least one antidegradant, about 5 to about 10 parts by weight per 100 parts rubber of at least one antidegradant, or about 10 to about 20 parts by weight per 100 parts rubber of at least one antidegradant.

The measured properties of the rubber composition and their testing instruments and methods are shown in Table 1.

TABLE 1

| Performance Indicator | Measurement | Equipment | Method |
|---|---|---|---|
| Processing Indicator | Mooney Viscosity, ML(1 + 4) | Monsanto MV2000 | ASTM D-1646 |
| | 100° C. | | |
| Processing Indication | Mooney Scorch, 3 point rise or | Monsanto MV2000 | ASTM D-1646 |
| | 10 points | | |
| Processing Indicator | MDR MIN/MAX Torque T10, | MDR2000 | ASTM F5289-12 |
| | 40, 90, 95 | | |
| | Specific Gravity | Wallace Electronic | ASTM-D-297 |
| | | Densimeter | |
| Wear Indicator | Tensile Strength | CubeOne Tensilemeter | ASTM D-412 |
| Wear Indicator | % Elongation | CubeOne Tensilemeter | ASTM D-412 |
| Wear Indicator | Modulus, M50, 100, 200, 300, | CubeOne Tensilemeter | ASTM D-412 |
| | Break Energy, Graves Tear @ | | |
| | 25° C. | | |
| Handling Indicator | Shore A Hardness | Zwick Shore Hardness | ASTM D-2240 |
| | | Tester | |
| Wear Indicator | DIN Abrasion (mass loss) | DIN Rotary Abrader | ASTM D-5963 |
| Grip Indicator Rolling | Rebound at 0° C. | Zwick 5109 Rebound | ASTM D-7121 |
| Resistance | Rebound at 70° C. | Resilience Tester | |
| Rolling Resistance | RPA G′ @ 2% , 5%, 10% | TA RPA Elite | ASTM D-6601 |
| Indicator | RPA Tan 8 @ 2%, 5%, 10% | | |

In some aspects, the rubber composition has a Mooney viscosity of from about 40 MU to about 150 MU as measured using the ASTM D-1646 method. In a further aspect, the rubber composition has a Mooney viscosity of from about 120 MU to about 140 MU. In another aspect, the rubber composition has a Mooney viscosity of from about 40 MU to about 100 MU. In some aspects, the rubber composition has a Mooney viscosity of about 40, about 45, about 50, about 55, about 60, about 65, about 70, about 75, about 80, about 85, about 90, about 95, about 100, about 105, about 110, about 115, about 120, about 125, about 130, about 135, about 140, about 145, or about 150 MU.

In some aspects, the rubber composition has a tensile strength of from about 5 MPa to about 25 MPa as measured by the ASTM D-412 method. In a further aspect, the rubber composition has a tensile strength of from about 15 MPA to about 20 MPa. In another aspect, the rubber composition has a tensile strength of from about 10 MPa to about 15 MPa. In some aspects, the rubber composition has a tensile strength of about 5, about 10, about 15, about 20, or about 25 MPa.

The disclosure further provides to an article of manufacture comprising the rubber composition described above. In some aspects, the article of manufacture includes but is not limited to a tire, a conveyor belt, an engine mount, a shoe sole, a tubing, a glove, a windshield wiper, a brake pad, an eraser, a rubber band, a grip, a brayer, a flame retardant, and a polishing pad.

In some aspects, the rubber composition is used in the manufacture of a tire tread, a tire undertread, a tire carcass, a tire sidewall, or a tire bead.

### EXAMPLES

The following examples are included to demonstrate various aspects of the present disclosure. It should be appreciated by those of skill in the art that the techniques disclosed in the examples that follow represent techniques discovered by the inventors to function well in the practice of the disclosure, and thus can be considered to constitute preferred modes for its practice. However, those of skill in the art should, in light of the present disclosure, appreciate that many changes can be made in the specific examples which are disclosed and still obtain a like or similar result without departing from the spirit and scope of the disclosure.

### Example 1: Comparative Silane

3-(1,3-dimethylbutyldiene)aminopropyltriethoxysilane (Momentive Performance Materials Inc.) is used as Comparative Silane.

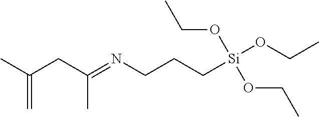 [SMILES: C=C(C)C/C(C)=N/CCC[Si](OCC)(OCC)OCC]

### 3-(1,3-dimethylbutyldiene)aminopropyltriethoxysilane

### Example 2: Synthesis of 3-(2,4-dimethyl-1,3,2-dioxasilinan-2-yl) propan-1-amine

3-aminopropyldiethoxymethylsilane (382 g (TCI Chemicals)) and 1,3-butanediol (215.9 g (Acros Organics)), and 1,8-diazabicyclo [5.4.0]undec-7-ene (0.3 g (Aldrich)) were charged to a round bottom flask equipped with stirrer, heating mantle, temperature controller, nitrogen inlet, and distillation head. The reaction was heated to 100° C. under 100 mmHg vacuum for a total of 16 hours during which ethanol was stripped from the reaction mixture. The resulting product, 3-(2,4-dimethyl-1,3,2-dioxasilinan-2-yl) propan-1-amine, was distilled to 87° C. and 4 mmHg, and then characterized by gas chromatography (GC) and Fourier transform infrared (FTIR) spectroscopy.

### Example 3: Synthesis of N-[3-(2,4-dimethyl-1,3,2-dioxasilinan-2-yl) propyl]-4-methyl-pentan-2-imine (Silane A)

3-(2,4-dimethyl-1,3,2-dioxasilinan-2-yl) propan-1-amine (181.2 g) and N-(1,3-dimethylbutylidene)-1-butanamine (148.6 g) were charged to a round bottom flask equipped with stirrer, heating mantle, temperature controller, nitrogen inlet, 10 plate distillation column, and distillation head. The reaction was heated to 80° C. while gradually lowering the vacuum to 5 mmHg over 8 hours, during which n-butylamine was stripped from the reaction mixture and NaOEt solution (21% in ethanol, 0.13 g) was charged to the reaction flask. The resulting product, N-[3-(2,4-dimethyl-1,3,2-dioxasilinan-2-yl) propyl]-4-methyl-pentan-2-imine, was distilled at 140-160° C. at 5-7 mmHg, and was characterized by GC, GC/MS, ²⁹Si NMR, and ¹³C NMR.

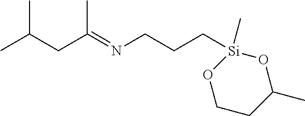 [SMILES: C/C(CC(C)C)=N\CCC[Si]1(C)OCCC(C)O1]

### N-[3-(2,4-dimethyl-1,3,2-dioxasilinan-2-yl) propyl]-4-methyl-pentan-2-imine

### Example 4: Synthesis of N-butyl-4-methyl-pentan-2-imine

A 250 mL three-neck round bottom flask was assembled with thermometer pocket, addition funnel, a Dean-Stark apparatus, and a condenser on top of it. Methyl isobutyl ketone (MIBK) (80 g, 99 mL, 0.79 mol) and butylamine (61.34 g, 82.89 mL, 0.839 mol) was added along with cyclohexane (50 mL) and stirred for 5 hour until the MIBK is consumed. The solvent was evaporated using rotary evaporation and the product (N-butyl-4-methyl-penta-2-imine) was characterized by GC, GC/MS, ¹H NMR, and ¹³C NMR.

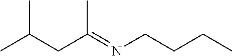

### N-butyl-4-methyl-pentan-2-imine

### Example 5: Synthesis of (E)-3-[dibenzyloxy(methyl) silyl]propan-1-amine

To a 100 mL three-neck round bottom flask assembled with thermometer pocket, septum, and condenser, was added 3-aminopropylmethyldiethoxysilane (100 g, 109 mL, 0.523 mol) and benzyl alcohol (282.59 g, 271 mL, 2.613 mol) and stirred at 110° C. for 8 hours. The reaction was monitored by GC/MS until the disappearance of the starting material (3-aminopropylmethyldiethoxysilane) was observed. The excess benzyl alcohol was distilled off and the product ((E)-3-[dibenzyloxy(methyl) silyl]propan-1-amine) obtained was characterized by GC, GC/MS, ¹H NMR, and ²⁹Si NMR.

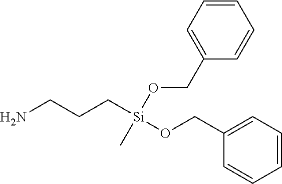 [SMILES: C[Si](CCCN)(OCc1ccccc1)OCc1ccccc1]

### 3-[dibenzyloxy(methyl) silyl]propan-1-amine

### Example 6: Synthesis of (E)-N-[3-[dibenzyloxy(methyl) silyl]propyl]-4-methyl-pentan-2-imine (Silane B)

To a 100 mL three-neck round bottom flask assembled with thermometer pocket, septum, and condenser, was added 3-[dibenzyloxy(methyl) silyl]propan-1-amine (25 g, 24 mL, 0.079 mol) and N-butyl-4-methyl-pentan-2-imine (18.45 g, 0.119 mol) and was stirred at 60° C. for 4 hours. The n-butylamine was stripped off continuously to afford the product which was characterized by GC, GC/MS, ¹H NMR, and ²⁹Si NMR.

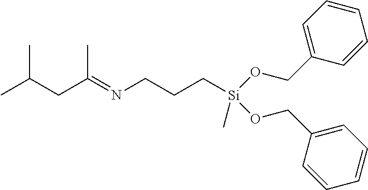 [SMILES: C/C(CC(C)C)=N\CCC[Si](C)(OCc1ccccc1)OCc1ccccc1]

### (E)-N-[3-[dibenzyloxy(methyl) silyl]propyl]-4-methyl-pentan-2-imine

### Example 7: Functionalization Procedure with SSBR

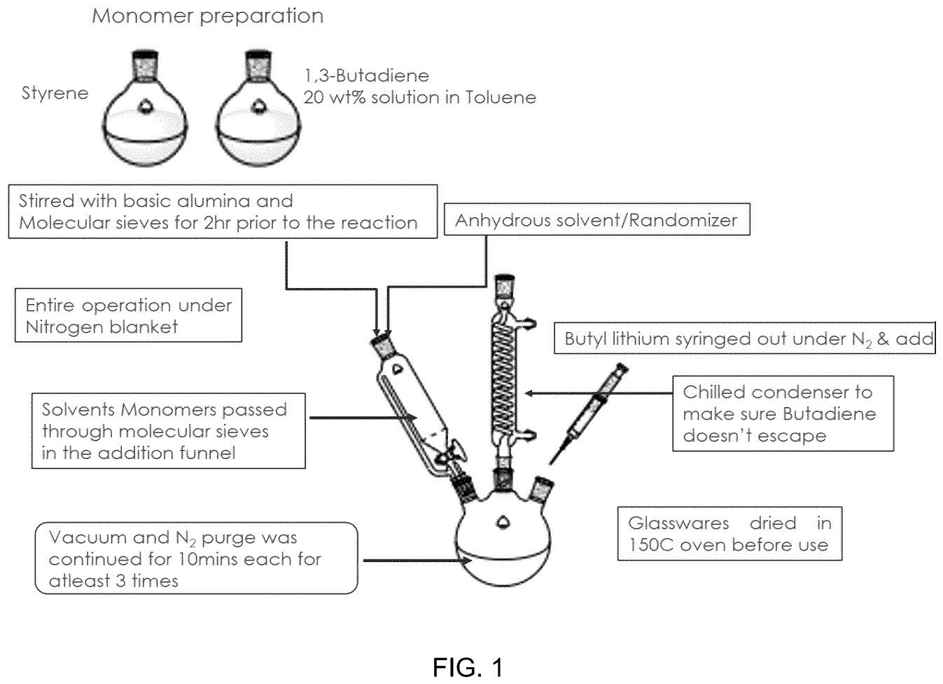

Reaction set-up: The anionic polymerization initiated using n-butyl lithium is very sensitive to moisture and so the following precautions were taken to make sure that the polymerization happened properly without the initiator getting quenched. Initially the monomers styrene and 1,3-butadiene were stirred separately for 2 hours in basic alumina (to remove the inhibitor) and 3 Å molecular sieves (to scavenge the moisture). All the glassware was dried in an oven at 150° C. and assembled when hot as shown in FIG. 1, with all open ports covered. A four-neck round bottom flask was used with 1 port each for condenser, addition funnel, thermometer pocket, a silicone septum port for addition of initiator and randomizer via syringe, and a heating mantle and stirrer (to heat with stirring) the contents of the flask. Before use, the round bottom flask was dried and purged with nitrogen then with vacuum for 10 minutes each for 3 times.

### Example 8: Unfunctionalized SSBR

To a flask was added toluene (170 g, 218 mL), 1,3-butadiene (15 wt % in hexane) (140.22 g, 2.59 mol, 1405.75 mL), styrene (30 g, 0.288 mol, 33 mL), and tetrahydrofuran (21 g, 23.9 mL) through an addition funnel packed with molecular sieves. Then n-butyllithium (2 M solution in cyclohexane) (0.92 g, 0.014 mol, 7.20 mL) was syringed into the flask under N₂ and added in one shot to the reaction mixture. A quick exotherm was observed, wherein the temperature of the reaction mixture increased from 23° C. to 50° C. in 5 minutes and then was allowed to cool to room temperature. The reaction solution was subjected to polymerization at 50° C. for 4 hours. No precipitation was observed in the polymerization system and the system was homogeneous and transparent from the start to the completion of polymerization.

Steam-stripping process: Distilled water was pumped in at 2 mL per minute through copper tubes in oil heated at 125° C. and the steam generated was injected inside the reaction mixture to distill the solvent. The remaining water was removed by adding excess toluene followed by rotary evaporation to remove water as an azeotrope and to obtain unfunctionalized SSBR. Further the volatiles were stripped at 70° C. under high vacuum for about 5 hours to obtain a rubbery polymer. The sample was characterized by ¹H NMR, ¹³C NMR, ²⁹Si NMR, and gas phase chromatography (GPC).

### Example 9: Functionalized SSBR Comparative Silane

After completion of polymerization as described in Example 8, 3-(1,3-dimethylbutylidene)aminopropyltriethoxysilane (3.8 g, 0.007 mol, 4.4 mL) was added as a coupling agent and the reaction mixture was allowed to react overnight to complete the end capping. Then the heating was stopped and the reaction mixture was cooled to room temperature.

Steam-stripping process: Distilled water was pumped in at 2 mL per minute through copper tubes in oil heated at 125° C. and the steam generated was injected into the reaction mixture to distill the solvent. Then remaining water was removed by adding excess toluene and water was removed using rotary evaporation an as azeotrope to obtain a functionalized. SSBR. Further the volatiles were stripped at 70° C. under high vacuum for about 5 hours to obtain a rubbery polymer. The sample was characterized by ¹H NMR, ¹³C NMR, ²⁹Si NMR, and GPC.

### Example 10: Functionalized SSBR with Silane A

After the completion of polymerization as described in Example 8, (E)-N-[3-(2,4-dimethyl-1,3,2-dioxasilinan-2-yl) propyl]-4-methyl-pentan-2-imine (Silane A) (3.8 g, 0.007 mol, 4.4 mL) was added as the coupling agent, the reaction mixture was heated, and allowed to react overnight to complete the end capping. Then the heating was stopped and the reaction mixture was cooled to room temperature.

Steam-stripping process: Distilled water pumped in at 2 mL per minute through copper tubes in oil was heated at 125° C. and the steam generated was injected into the reaction mixture to distill the solvent. The remaining water was removed by adding excess toluene followed by rotary evaporation to remove water as azeotrope and to obtain Silane A functionalized SSBR. Further the volatiles were stripped at 70° C. under high vacuum for about 5 hours to obtain a rubbery polymer. The sample was characterized by ¹H NMR, ¹³C NMR, ²⁹Si NMR, and GPC.

### Example 11: Functionalized SSBR with Silane B

After completion of polymerization as described in Example 8, (E)-N-[3-[dibenzyloxy(methyl) silyl]propyl]-4-methyl-pentan-2-imine (Silane B) (0.7 g, 0.02 mol, 0.9 mL) was added as the coupling agent and was allowed to react overnight to complete the end capping. Then the heating was stopped and the reaction mixture cooled to room temperature.

Steam-stripping process: Distilled water was pumped in at 2 mL per minute through copper tubes in oil heated at 125° C. and the steam generated was injected into the reaction mixture to distill the solvent. The remaining water was removed by adding excess toluene followed by rotary evaporation to remove water as an azeotrope and to obtain Silane B functionalized SSBR. Further the volatiles were stripped at 70° C. under high vacuum for about 5 hours to obtain a rubbery polymer. The sample was characterized by ¹H NMR, ¹³C NMR, ²⁹Si NMR, and GPC.

TABLE 2
Ageing Data of Steam-Stripped Silane Functionalized SSBRs

| | | | | | | Percentage |
|---|---|---|---|---|---|---|
| | | | | | Percent | Point |
| Steam-stripped | | | GPC results | | increase in | Increase of |
| Silane | GPC results | | Mn (peak %) | | abundance of | “2 chains” |
| functionalized | Mn (%) | | 1 month | | “2 polymer | peak |
| SSBR | before ageing | | ageing @ RT | | chains” peak | (% point) |
| Functionalized | 106597 | (10.3%) | 120398 | (16.3%) | 58 | +6.0 |
| SSBR Comparative | 44746 | (89.6%) | 60602 | (83.9%) | | |
| Silane | | | | | | |
| Silane A | 85419 | (15.7%) | 83105 | (15.3%) | −2.55 | −0.4 |
| Functionalized | 39595 | (84.2%) | 38523 | (84.4%) | | |
| SSBR | | | | | | |
| Silane B | 47105 | (1.92%) | 43683 | (2.41%) | 25.5 | +0.49 |
| Functionalized | 15766 | (98.07%) | 14697 | (97.59%) | | |
| SSBR | | | | | | |

### Example 12: Rubber Compositions Comprising Comparative Silane Functionalized SSBR, Silane A Functionalized SSBR, and Silane B Functionalized SSBR

TABLE 3 presents the ingredients used to prepare rubber compositions using a 75:25 blend of polystyrene-butadiene (SBR) and cis-1,4-polybutadiene (BR) with silica coupled using NXT™ Silane (Momentive Performance Materials Inc.) as the coupling agent. The rubber compositions were mixed using a Banbury BR1600 mixer with two non-productive stages and one productive stage. Each composition included additional non-functionalized reference polymers or functionalized polymers, prepared using the method described in Examples 8-11 with the appropriate silane. The functionalized SSBRs were used at a concentration of 7.5 phr (parts per hundred rubber) to assess their coupling efficiency to the silica. The Non-Func reference SSBR served as the control, and the steam striped comparative functionalized SSBR was used to evaluate the impact of hydrolysis on its coupling efficiency to silica. The mixed composition underwent a curing process, and the cured rubber was then molded into the desired shapes or forms. The molded specimens were subsequently employed for conducting various tests to evaluated properties as listed in TABLE 4. To minimize batch-to-batch variation, three separate Non-Func reference SSBRs were used. Each reference SSBR was divided into two equal parts, with one part used as the reference SSBR and the other part functionalized with the appropriate silane. This approach aimed to reduce structural differences between the reference SSBR and functionalized SSBR compared to using a single general Non-Func reference SSBR.

TABLE 3
Components of Prepared Rubber Compositions

| | Non-Func | | | | | |
|---|---|---|---|---|---|---|
| | reference | Steam | Non-Func | | Non-Func | |
| | SSBR for | stripped | reference | Steam | reference | Steam |
| | Comparative | Comparative | SSBR for | stripped | polymer for | stripped |
| | Silane | Silane | Silane A | Silane A | Silane B | Silane B |
| | functionalized | functionalized | functionalized | functionalized | functionalized | functionalized |
| | SSBR | SSBR | SSBR | SSBR | SSBR | SSBR |
| Ingredients | | | | | | |
| 1st Non-Productive | | | | | | |
| Polystyrene-butadiene ¹ | 75.0 | 75.0 | 75.0 | 75.0 | 75.0 | 75.0 |
| Cis 1,4-Polybutadiene ² | 25.0 | 25.0 | 25.0 | 25.0 | 25.0 | 25.0 |
| Silica ³ | 80.0 | 80.0 | 80.0 | 80.0 | 80.0 | 80.0 |
| Carbon Black ⁴ | 5.0 | 5.0 | 5.0 | 5.0 | 5.0 | 5.0 |
| 6-PPD ⁵ | 2.0 | 2.0 | 2.0 | 2.0 | 2.0 | 2.0 |
| TMQ ⁶ | 1.0 | 1.0 | 1.0 | 1.0 | 1.0 | 1.0 |
| Microcystalline Wax | 2.0 | 2.0 | 2.0 | 2.0 | 2.0 | 2.0 |
| TDAE Process Oil | 7.5 | 7.5 | 7.5 | 7.5 | 7.5 | 7.5 |
| NXT ™ silane | 6.4 | 6.4 | 6.4 | 6.4 | 6.4 | 6.4 |
| Zinc Oxide | 2.5 | 2.5 | 2.5 | 2.5 | 2.5 | 2.5 |
| Stearic Acid | 2.0 | 2.0 | 2.0 | 2.0 | 2.0 | 2.0 |
| Non-Func reference | 7.5 | | | | | |
| SSBR for Comparative | | | | | | |
| Silane functionalized | | | | | | |
| SSBR | | | | | | |
| Steam Stripped | | 7.5 | | | | |
| Comparative Silane | | | | | | |
| functionalized SSBR | | | | | | |
| Non-Func reference SSBR | | | 7.5 | | | |
| for Silane A | | | | | | |
| functionalized SSBR | | | | | | |
| Steam Stripped Silane A | | | | 7.5 | | |
| functionalized SSBR | | | | | | |
| Non-Func reference | | | | | 7.5 | |
| polymer for Silane B | | | | | | |
| functionalized SSBR | | | | | | |
| Steam Stripped Silane B | | | | | | 7.5 |
| functionalized SSBR | | | | | | |
| NP1 Total | 215.9 | 215.9 | 215.9 | 215.9 | 215.9 | 215.9 |
| 2nd Non-Productive | | | | | | |
| NP2 Total | 215.9 | 215.9 | 215.9 | 215.9 | 215.9 | 215.9 |
| Productive | | | | | | |
| Sulfur | 2.0 | 2.0 | 2.0 | 2.0 | 2.0 | 2.0 |
| CBS ⁷ | 2.5 | 2.5 | 2.5 | 2.5 | 2.5 | 2.5 |
| DPG ⁸ | 2.0 | 2.0 | 2.0 | 2.0 | 2.0 | 2.0 |
| FM Total | 222.4 | 222.4 | 222.4 | 222.4 | 222.4 | 222.4 |

¹ Polystyrene-butadiene (Buna SL4525 (Arlanxeo))
² High cis 1,4-polybutdadiene rubber ((Kibipol HBR PR-040G (Chi Mei Corporation)).
³ Zeosil 1165MP (Solvay)
⁴ N330 carbon black (Cabot Corporation)
⁵ N-1,3-dimethylbutyl-N-phenyl-para-phenylenediamine (Harwick Standard Distribution Corporation)
⁶ 2,2,4-Trimethyl-1,2-dihydroquinoline polymer (NOCIL)
⁷ N-Cyclohexyl-2-benzothiazole sulfonamide (Harwick Standard Distribution Corporation)
⁸ Diphenylguanidine (Harwick Standard Distribution Corporation)

The test procedures for evaluating the vulcanized (cured) rubber compositions herein are described using the ASTM or DIN methods described in Table 1.

TABLE 4 lists the properties of the prepared rubber compositions. The functionalized SSBRs showed improved Mooney viscosity due to increased filler-polymer bonding in comparison to respective reference unfunctionalized SSBR. M300% modulus also showed improvement for the functionalized SSBR versus unfunctionalized SSBR indicating increased filler-polymer chemical bonding. RPA 2000 strain sweep showed decreased tan δ@10% indicating better rolling resistance for tire performance. All other data aligns with the trend that when the SSBRs were functionalized with silanes to reduce Mooney instability of terminal functionalized SSBR, the functionalized SSBR didn't show compromise in performance, especially for rolling resistance.

TABLE 4
Properties of the Prepared Rubber Compositions

| | | Non-Func | | Non-Func | | Non-Func | |
|---|---|---|---|---|---|---|---|
| | | Base reference | | Reference | Steam | reference | Steam |
| | | SSBR for | Steam stripped | SSBR | stripped | polymer for | stripped |
| | | Comparative | Comparative | for Silane A | Silane A | Silane B | Silane B |
| | | functionalized | functionazlied | functionalized | functionalized | functionalized | functionalized |
| | Units | SSBR | SSBR | SSBR | SSBR | SSBR | SSBR |
| MB1 CMS1 + 4(100° C.) | MU | 153.0 | 158.9 | 159.5 | 163.1 | 139.0 | 144.0 |
| MB2 CMS1 + 4(100° C.) | MU | 116.8 | 115.7 | 111.1 | 111.6 | 97.7 | 101.7 |
| FM CML1 + 4(100° C.) | MU | 71.7 | 72.2 | 70.2 | 71.0 | 64.6 | 64.4 |
| Mooney Scorch, 3 pt rise | minutes | 11.9 | 11.2 | 11.7 | 11.4 | 11.6 | 10.2 |
| Mooney Scorch, 10 pt rise | minutes | 14.3 | 13.6 | 14.3 | 14.0 | 14.3 | 12.7 |
| MDR MIN Torque | dNm | 3.06 | 2.97 | 2.80 | 2.72 | 2.36 | 2.37 |
| MDR MAX Torque | dNm | 31.82 | 30.84 | 30.14 | 29.13 | 28.66 | 28.64 |
| T 10 (minutes) | minutes | 2.5 | 2.3 | 2.5 | 2.4 | 2.6 | 2.3 |
| T 40 (minutes) | minutes | 3.4 | 3.2 | 3.5 | 3.3 | 3.4 | 3.1 |
| T 90 (minutes) | minutes | 6.3 | 6.0 | 6.3 | 6.1 | 5.9 | 5.6 |
| T 95 (minutes | minutes | 8.5 | 7.8 | 8.1 | 8.0 | 7.6 | 7.3 |
| Specific Gravity | g/cm | 1.206 | 1.207 | 1.208 | 1.207 | 1.205 | 1.206 |
| 50% Modulus | MPa | 2.2 | 2.2 | 2.2 | 2.2 | 2.1 | 2.1 |
| 100% Modulus (M100) | MPa | 3.8 | 3.8 | 3.8 | 3.7 | 3.6 | 3.7 |
| 200% Modulus | MPa | 8.8 | 8.8 | 8.6 | 8.3 | 8.4 | 8.6 |
| 300% Modulus (M300) | MPa | 15.6 | 15.5 | 15.2 | 14.7 | 14.7 | 15.1 |
| Reinforcing Index | Unitless | 4.1 | 4.1 | 4.0 | 4.0 | 4.0 | 4.1 |
| (M300/M100) | | | | | | | |
| M300 − M100 | MPa | 11.7 | 11.8 | 11.4 | 11.1 | 11.0 | 11.4 |
| Tensile Strength | MPa | 13.6 | 16.5 | 16.5 | 15.9 | 14.8 | 15.7 |
| Elongation (%) | % | 297 | 341 | 349 | 346 | 330 | 337 |
| Break Energy | J | 60.9 | 81.6 | 83.9 | 80.9 | 72.6 | 77.0 |
| Work-to-Break | J/cm³ | 16.73 | 22.50 | 23.22 | 22.33 | 19.91 | 21.20 |
| Shore A @ 25° C., point | Shore A | 77.5 | 75.9 | 77.3 | 76.5 | 74.1 | 74.0 |
| Shore A @ 70° C., point | Shore A | 74.3 | 73.5 | 74.4 | 73.9 | 72.4 | 72.5 |
| Graves Tear @ 25° C. | kN/m | 47.2 | 46.5 | 47.3 | 47.6 | 49.0 | 46.9 |
| DIN Abrasion: | mm³ | 87.0 | 84.1 | 80.3 | 77.6 | 71.5 | 72.4 |
| Rebound at 0° C. | % | 33.7 | 34.7 | 33.2 | 34.0 | 32.2 | 34.0 |
| Rebound at 25° C. | % | 40.4 | 41.1 | 40.8 | 41.0 | 40.0 | 39.6 |
| Rebound at 70° C. | % | 49.0 | 49.3 | 47.5 | 48.7 | 48.8 | 49.5 |
| RPA G′ @ 2% | MPa | 9.6 | 9.2 | 9.4 | 9.1 | 5.8 | 7.5 |
| RPA G′ @ 5% | MPa | 6.6 | 6.3 | 6.5 | 6.3 | 4.1 | 5.1 |
| RPA G′ @ 10% | MPa | 4.4 | 4.3 | 4.3 | 4.4 | 3.1 | 3.7 |
| RPA Tan δ @ 2% | Unitless | 0.109 | 0.110 | 0.096 | 0.097 | 0.170 | 0.138 |
| RPA Tan δ @ 5% | Unitless | 0.140 | 0.141 | 0.133 | 0.131 | 0.197 | 0.181 |
| RPA Tan δ @ 10% | Unitless | 0.157 | 0.156 | 0.159 | 0.146 | 0.219 | 0.214 |

### OTHER ASPECTS

All publications, patents, and patent applications mentioned in this specification are incorporated herein by reference in their entirety to the same extent as if each individual publication, patent, or patent application was specifically and individually indicated to be incorporated by reference in its entirety. Where a term in the present application is found to be defined differently in a document incorporated herein by reference, the definition provided herein is to serve as the definition for the term.

While the invention has been described in connection with specific aspects thereof, it will be understood that the invention is capable of further modifications and this application is intended to cover any variations, uses, or adaptations of the invention following, in general, the principles of the invention and including such departures from the present disclosure that come within known or customary practice within the art to which the invention pertains and can be applied to the essential features hereinbefore set forth, and follows in the scope of the claimed invention.

1. A silane compound of Formula (I): 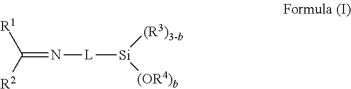
wherein
each R¹ and R² independently is hydrogen; an optionally substituted alkyl group having from 1 to 20 carbon atoms, where the optional substituent is one or more heteroatom; an optionally substituted alkenyl group having from 2 to 20 carbon atoms, where the optional substituent is one or more heteroatom; an optionally substituted cycloalkyl group having from 3 to 10 carbon atoms, where the optional substituent is one or more heteroatom; an optionally substituted aryl group having from 6 to 12 carbon atoms, where the optional substituent is one or more heteroatom; or an optionally substituted aralkyl group having from 7 to 16 carbon atoms, where the optional substituent is one or more heteroatom;
L is an optionally substituted alkylene group having from 1 to 20 carbon atoms, where the optional substituent is one or more heteroatom; an optionally substituted alkenylene group having from 2 to 20 carbon atoms, where the optional substituent is one or more heteroatom; an optionally substituted cycloalkylene group having from 3 to 10 carbon atoms, where the optional substituent is one or more heteroatom; an optionally substituted arylene group having from 6 to 12 carbon atoms, where the optional substituent is one or more heteroatom; or an optionally substituted aralkylene group having from 7 to 16 carbon atoms, where the optional substituent is one or more heteroatom;
R³ is an optionally substituted alkyl group having from 1 to 20 carbon atoms, where the optional substituent is one or more heteroatom; an optionally substituted alkenyl group having from 2 to 20 carbon atoms, where the optional substituent is one or more heteroatom; an optionally substituted cycloalkyl group having from 3 to 10 carbon atoms, where the optional substituent is one or more heteroatom; an optionally substituted aryl group having from 6 to 12 carbon atoms, where the optional substituent is one or more heteroatom; or an optionally substituted aralkyl group having from 7 to 16 carbon atoms, where the optional substituent is one or more heteroatom;
each R⁴ independently is an optionally substituted alkyl group having from 6 to 30 carbon atoms, where the optional substituent is one or more heteroatom; an optionally substituted alkenyl group having from 6 to 30 carbon atoms, where the optional substituent is one or more heteroatom;
an optionally substituted alkynyl group having from 6 to 30 carbon atoms, where the optional substituent is one or more heteroatom; an optionally substituted cycloalkyl group having from 3 to 10 carbon atoms, where the optional substituent is one or more heteroatom; an optionally substituted aryl group having from 6 to 12 carbon atoms, where the optional substituent is one or more heteroatom; an optionally substituted aralkyl group having from 7 to 20 carbon atoms, where the optional substituent is one or more heteroatom; or an optionally substituted cyclic silane; or
R⁴ is R²³, where each R²³ independently is an optionally substituted straight chain or branched chain alkyl group, having from 1 to 10 carbon atoms, where two R²³ combine with each other to form a ring together with the —O—Si—O— atoms to which they are bonded, and where the optional substituent is one or more heteroatom, and wherein the two R²³ can be the same or different; or
each R⁴ independently is a group represented by —(R⁵—O)ₘ—R⁶, where each R⁵ is the same as or different from each other and each represents a branched or unbranched C₁-C₃₀ divalent hydrocarbon group; R⁶ represents a branched or unbranched C₁-C₃₀ alkyl group, a branched or unbranched C₂-C₃₀ alkenyl group, a C₆-C₃₀ aryl group, or a C₇-C₃₀ aralkyl group; and m is an integer of 1 to 30; and
b is 2 or 3.

2. The silane compound of claim 1, wherein two R⁴ are a C₇-C₂₀ aralkyl group.

3. The silane compound of claim 1, wherein two R²³ combine with each other to form a ring comprising an optionally substituted —(C₂-C₁₀ alkyl)— group together with the —O—Si—O— atoms to which they are bonded.

4. The silane compound of claim 1, wherein L is a C₂-C₁₂ alkylene group.

5. The silane compound of claim 1, wherein R¹ is an optionally substituted C₁-C₂₀ alkyl group.

6. The silane compound of claim 1, wherein R² is an optionally substituted C₁-C₂₀ alkyl group.

7. (canceled)

8. The silane compound of claim 11, wherein two R²³ combine with each other to form a ring comprising —CH₂CH₂CH(CH₃)— together with the —O—Si—O— atoms to which they are bonded.

9. The silane compound of claim 1, wherein the silane compound of Formula (I) is

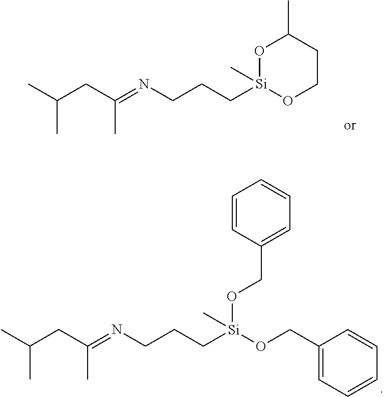 [SMILES: C/C(CC(C)C)=N\CCC[Si]1(C)OCCC(C)O1 ; C/C(CC(C)C)=N\CCC[Si](C)(OCc1ccccc1)OCc1ccccc1]

10. A polymer comprising:
(i) a conjugated diene-based polymer having an active chain end; and
(ii) a silane compound of claim 1;
wherein the polymer is a reaction product between the conjugated diene-based polymer and the silane compound.

11. A polymer represented by Formula (II) 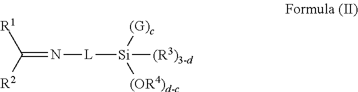
wherein
each R¹ and R² independently is hydrogen; an optionally substituted alkyl group having from 1 to 20 carbon atoms, where the optional substituent is one or more heteroatom; an optionally substituted alkenyl group having from 2 to 20 carbon atoms, where the optional substituents is one or more heteroatom; an optionally substituted cycloalkyl group having from 3 to 10 carbon atoms, where the optional substituent is one or more heteroatom; an optionally substituted aryl group having from 6 to 12 carbon atoms, where the optional substituent is one or more heteroatom; or an optionally substituted aralkyl group having from 7 to 16 carbon atoms, where the optional substituent is one or more heteroatom;
L is an optionally substituted alkylene group having from 1 to 20 carbon atoms, where the optional substituent is one or more heteroatom; an optionally substituted alkenylene group having from 2 to 20 carbon atoms, where the optional substituent is one or more heteroatom; an optionally substituted cycloalkylene group having from 3 to 10 carbon atoms, where the optional substituent is one or more heteroatom; an optionally substituted arylene group having from 6 to 12 carbon atoms, where the optional substituent is one or more heteroatom; or an optionally substituted aralkylene group having from 7 to 16 carbon atoms, where the optional substituent is one or more heteroatom;
R³ is an optionally substituted alkyl group having from 1 to 20 carbon atoms, where the optional substituent is one or more heteroatom; an optionally substituted alkenyl group having from 2 to 20 carbon atoms, where the optional substituent is one or more heteroatom; an optionally substituted cycloalkyl group having from 3 to 10 carbon atoms, where the optional substituent is one or more heteroatom; an optionally substituted aryl group having from 6 to 12 carbon atoms, where the optional substituent is one or more heteroatom; or an optionally substituted aralkyl group having from 7 to 16 carbon atoms, where the optional substituent is one or more heteroatom;
each R⁴ independently is an optionally substituted alkyl group having from 6 to 30 carbon atoms, where the optional substituent is one or more heteroatom; an optionally substituted alkenyl group having from 6 to 30 carbon atoms, where the optional substituent is one or more heteroatom; an optionally substituted alkynyl group having from 6 to 30 carbon atoms, where the optional substituent is one or more heteroatom; an optionally substituted cycloalkyl group having from 3 to 10 carbon atoms, where the optional substituent is one or more heteroatom; an optionally substituted aryl group having from 6 to 12 carbon atoms, where the optional substituent is one or more heteroatom; an optionally substituted aralkyl group having from 7 to 20 carbon atoms, where the optional substituent is one or more heteroatom; or an optionally substituted cyclic silane; or
R⁴ is R²³, where each R²³ independently is an optionally substituted straight chain or branched chain alkyl group, having from 1 to 10 carbon atoms, where two R²³ combine with each other to form a ring together with the —O—Si—O— atoms to which they are bonded, and where the optional substituent is one or more heteroatom, and wherein the two R²³ can be the same or different; each R⁴ independently is a group represented by —(R⁵—O)ₘ—R⁶, where each R⁵ is the same as or different from each other and each represents a branched or unbranched C₁-C₃₀ divalent hydrocarbon group; R⁶ represents a branched or unbranched C₁-C₃₀ alkyl group, a branched or unbranched C₂-C₃₀ alkenyl group, a C₆-C₃₀ aryl group, or a C₇-C₃₀ aralkyl group; and m is an integer of 1 to 30;
each G is independently a polymer fragment having a backbone of carbon atoms covalently bonded together by C—C single bond, C═C double bond, or a combination of C—C single bonds and C═C double bonds;
c is 1 or 2, with the proviso that c is equal to or less than d; and
d is 1, 2, or 3.

12. The polymer of claim 11, wherein the polymer fragment G is a styrene butadiene polymer.

13. The polymer of claim 11, wherein G is a polymer fragment of Formula (III) 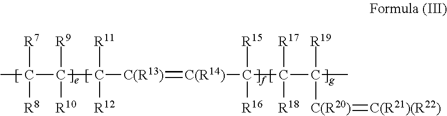
wherein
each R⁷, R⁸, R⁹, R¹¹, R¹², R¹³, R¹⁴, R¹⁵, R¹⁶, R¹⁷, R¹⁸, R¹⁹, R²⁰, R²¹, and R²² independently is hydrogen or an alkyl group having from 1 to 20 carbon atoms;
each R¹⁰ independently is hydrogen, an alkyl group having from 1 to 20 carbon atoms and optionally at least one heteroatom, an alkenyl group having from 2 to 20 carbon atoms, a cycloalkyl group having from 3 to 14 carbon atoms, a cycloalkenyl group having from 4 to 14 carbon atoms, an aryl group having from 6 to 16 carbon atoms, or an aralkyl group having from 7 to 20 carbon atoms; and
e, f, and g are integers, wherein e is equal to or greater than 0, f is equal to or greater than 0, and g is equal to or greater than 0, with the proviso that the sum of e, f, and g is equal to or greater than 1.

14. The polymer of claim 11, wherein the polymer of Formula (II) is

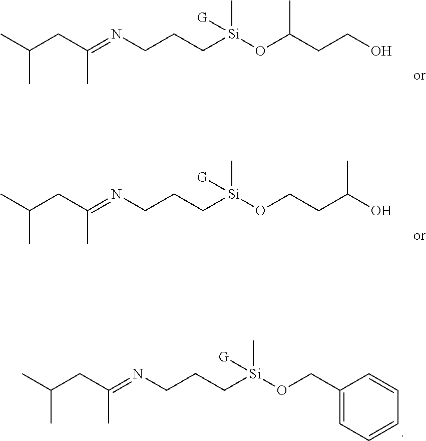

15. A polymer represented by Formula (IV) 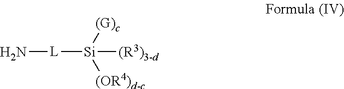
wherein
L is an optionally substituted alkylene group having from 1 to 20 carbon atoms, where the optional substituent is one or more heteroatom; an optionally substituted alkenylene group having from 2 to 20 carbon atoms, where the optional substituent is one or more heteroatom; an optionally substituted cycloalkylene group having from 3 to 10 carbon atoms, where the optional substituent is one or more heteroatom; an optionally substituted arylene group having from 6 to 12 carbon atoms, where the optional substituent is one or more heteroatom; or an optionally substituted aralkylene group having from 7 to 16 carbon atoms, where the optional substituent is one or more heteroatom;
R³ is an optionally substituted alkyl group having from 1 to 20 carbon atoms, where the optional substituent is one or more heteroatom; an optionally substituted alkenyl group having from 2 to 20 carbon atoms, where the optional substituent is one or more heteroatom; an optionally substituted cycloalkyl group having from 3 to 10 carbon atoms, where the optional substituent is one or more heteroatom; an optionally substituted aryl group having from 6 to 12 carbon atoms, where the optional substituent is one or more heteroatom; or an optionally substituted aralkyl group having from 7 to 16 carbon atoms, where the optional substituent is one or more heteroatom;
each R⁴ independently is an optionally substituted alkyl group having from 6 to 30 carbon atoms, where the optional substituent is one or more heteroatom; an optionally substituted alkenyl group having from 6 to 30 carbon atoms, where the optional substituent is one or more heteroatom; an optionally substituted alkynyl group having from 6 to 30 carbon atoms, where the optional substituent is one or more heteroatom; an optionally substituted cycloalkyl group having from 3 to 10 carbon atoms, where the optional substituent is one or more heteroatom; an optionally substituted aryl group having from 6 to 12 carbon atoms, where the optional substituent is one or more heteroatom; an optionally substituted aralkyl group having from 7 to 20 carbon atoms, where the optional substituent is one or more heteroatom; or an optionally substituted cyclic silane; or
R⁴ is R²³, where each R²³ independently is an optionally substituted straight chain or branched chain alkyl group, having from 1 to 10 carbon atoms, where two R²³ combine with each other to form a ring together with the —O—Si—O— atoms to which they are bonded, and where the optional substituent is one or more heteroatom, and wherein the two R²³ can be the same or different; or
each R⁴ independently is a group represented by —(R⁵—O)ₘ—R⁶, where each R⁵ is the same as or different from each other and each represents a branched or unbranched C₁-C₃₀ divalent hydrocarbon group; R⁶ represents a branched or unbranched C₁-C₃₀ alkyl group, a branched or unbranched C₂-C₃₀ alkenyl group, a C₆-C₃₀ aryl group, or a C₇-C₃₀ aralkyl group; and m is an integer of 1 to 30;
c is 1 or 2, with the proviso that c is equal to or less than d;
d is 2 or 3; and
each G is independently a polymer fragment having a backbone of carbon atoms covalently bonded together by C—C single bond, C═C double bond, or a combination of C—C single bonds and C═C double bonds.

16. A method of making the silane compound of Formula (I) 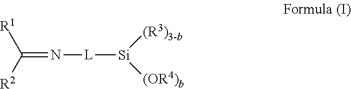
of claim 1, comprising:
reacting a compound of Formula (V) 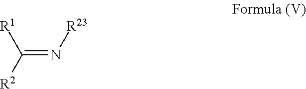
with a compound of Formula (VI) 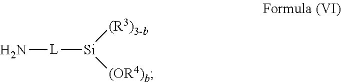
wherein
each R¹ and R² independently is hydrogen; an optionally substituted alkyl group having from 1 to 20 carbon atoms, where the optional substituent is one or more heteroatom; an optionally substituted alkenyl group having from 2 to 20 carbon atoms, where the optional substituents is one or more heteroatom; an optionally substituted cycloalkyl group having from 3 to 10 carbon atoms, where the optional substituent is one or more heteroatom; an optionally substituted aryl group having from 6 to 12 carbon atoms, where the optional substituent is one or more heteroatom; or an optionally substituted aralkyl group having from 7 to 16 carbon atoms, where the optional substituent is one or more heteroatom;
L is an optionally substituted alkylene group having from 1 to 20 carbon atoms, where the optional substituent is one or more heteroatom; an optionally substituted alkenylene group having from 2 to 20 carbon atoms, where the optional substituent is one or more heteroatom; an optionally substituted cycloalkylene group having from 3 to 10 carbon atoms, where the optional substituent is one or more heteroatom; an optionally substituted arylene group having from 6 to 12 carbon atoms, where the optional substituent is one or more heteroatom; or an optionally substituted aralkylene group having from 7 to 16 carbon atoms, where the optional substituent is one or more heteroatom;
R³ is an optionally substituted alkyl group having from 1 to 20 carbon atoms, where the optional substituent is one or more heteroatom; an optionally substituted alkenyl group having from 2 to 20 carbon atoms, where the optional substituent is one or more heteroatom; an optionally substituted cycloalkyl group having from 3 to 10 carbon atoms, where the optional substituent is one or more heteroatom; an optionally substituted aryl group having from 6 to 12 carbon atoms, where the optional substituent is one or more heteroatom; or an optionally substituted aralkyl group having from 7 to 16 carbon atoms, where the optional substituent is one or more heteroatom;
each R⁴ independently is an optionally substituted alkyl group having from 6 to 30 carbon atoms, where the optional substituent is one or more heteroatom; an optionally substituted alkenyl group having from 6 to 30 carbon atoms, where the optional substituent is one or more heteroatom; an optionally substituted alkynyl group having from 6 to 30 carbon atoms, where the optional substituent is one or more heteroatom; an optionally substituted cycloalkyl group having from 3 to 10 carbon atoms, where the optional substituent is one or more heteroatom; an optionally substituted aryl group having from 6 to 12 carbon atoms, where the optional substituent is one or more heteroatom; an optionally substituted aralkyl group having from 7 to 20 carbon atoms, where the optional substituent is one or more heteroatom; or an optionally substituted cyclic silane; or
R⁴ is R²³, where each R²³ independently is an optionally substituted straight chain or branched chain alkyl group, having from 1 to 10 carbon atoms, where two R²³ combine with each other to form a ring together with the —O—Si—O— atoms to which they are bonded, and where the optional substituent is one or more heteroatom, and wherein the two R²³ can be the same or different; or
each R⁴ independently is a group represented by —(R⁵—O)ₘ—R⁶, where each R⁵ is the same as or different from each other and each represents a branched or unbranched C₁-C₃₀ divalent hydrocarbon group; R⁶ represents a branched or unbranched C₁-C₃₀ alkyl group, a branched or unbranched C₂-C₃₀ alkenyl group, a C₆-C₃₀ aryl group, or a C₇-C₃₀ aralkyl group; and m is an integer of 1 to 30; and
b is 2 or 3.

17. The method of claim 16, wherein
(a) when two R⁴ are 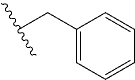 [SMILES: *Cc1ccccc1]
and b is 2, the silane compound of Formula (I) is 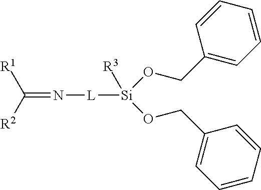
and is prepared by reacting the compound of Formula (V) 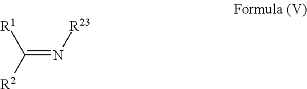
with a compound of Formula (VI) which is 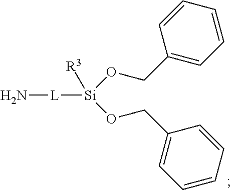
or
(b) when two R²³ combine with each other to form a ring comprising —CH₂CH₂CH(CH₃)— together with the —O—Si—O— atoms to which they are bonded, the silane compound of Formula (I) is 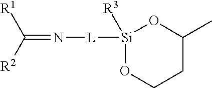
and is prepared by reacting the compound of Formula (V) 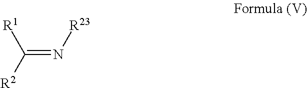
with a compound of Formula (VI) which is

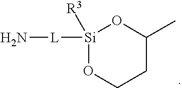

18. A method of making the polymer of claim 11, wherein the polymer is represented by Formula (II) 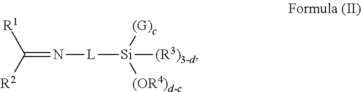
and is prepared by
(i) reacting a polymer fragment having a backbone of carbon atoms covalently bonded together by C—C single bond, C═C double bond, or a combination of C—C single bonds and C—C double bonds with an anionic initiator to form a polymer fragment G; and
(ii) reacting the polymer fragment G of (i) with a silane compound of Formula (I) 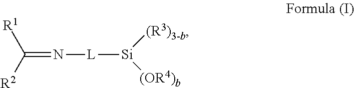
wherein
each R¹ and R² independently is hydrogen; an optionally substituted alkyl group having from 1 to 20 carbon atoms, where the optional substituent is one or more heteroatom; an optionally substituted alkenyl group having from 2 to 20 carbon atoms, where the optional substituents is one or more heteroatom; an optionally substituted cycloalkyl group having from 3 to 10 carbon atoms, where the optional substituent is one or more heteroatom; an optionally substituted aryl group having from 6 to 12 carbon atoms, where the optional substituent is one or more heteroatom; or an optionally substituted aralkyl group having from 7 to 16 carbon atoms, where the optional substituent is one or more heteroatom;
L is an optionally substituted alkylene group having from 1 to 20 carbon atoms, where the optional substituent is one or more heteroatom; an optionally substituted alkenylene group having from 2 to 20 carbon atoms, where the optional substituent is one or more heteroatom; an optionally substituted cycloalkylene group having from 3 to 10 carbon atoms, where the optional substituent is one or more heteroatom; an optionally substituted arylene group having from 6 to 12 carbon atoms, where the optional substituent is one or more heteroatom; or an optionally substituted aralkylene group having from 7 to 16 carbon atoms, where the optional substituent is one or more heteroatom;
R³ is an optionally substituted alkyl group having from 1 to 20 carbon atoms, where the optional substituent is one or more heteroatom; an optionally substituted alkenyl group having from 2 to 20 carbon atoms, where the optional substituent is one or more heteroatom; an optionally substituted cycloalkyl group having from 3 to 10 carbon atoms, where the optional substituent is one or more heteroatom; an optionally substituted aryl group having from 6 to 12 carbon atoms, where the optional substituent is one or more heteroatom; or an optionally substituted aralkyl group having from 7 to 16 carbon atoms, where the optional substituent is one or more heteroatom;
each R⁴ independently is an optionally substituted alkyl group having from 6 to 30 carbon atoms, where the optional substituent is one or more heteroatom; an optionally substituted alkenyl group having from 6 to 30 carbon atoms, where the optional substituent is one or more heteroatom; an optionally substituted alkynyl group having from 6 to 30 carbon atoms, where the optional substituent is one or more heteroatom; an optionally substituted cycloalkyl group having from 3 to 10 carbon atoms, where the optional substituent is one or more heteroatom; an optionally substituted aryl group having from 6 to 12 carbon atoms, where the optional substituent is one or more heteroatom; an optionally substituted aralkyl group having from 7 to 20 carbon atoms, where the optional substituent is one or more heteroatom; or an optionally substituted cyclic silane; or
R⁴ is R²³, where each R²³ independently is an optionally substituted straight chain or branched chain alkyl group, having from 1 to 10 carbon atoms, where two R²³ combine with each other to form a ring together with the —O—Si—O— atoms to which they are bonded, and where the optional substituent is one or more heteroatom, and wherein the two R²³ can be the same or different; or
each R⁴ independently is a group represented by —(R⁵—O)ₘ—R⁶, where where each R⁵ is the same as or different from each other and each represents a branched or unbranched C₁-C₃₀ divalent hydrocarbon group; R⁶ represents a branched or unbranched C₁-C₃₀ alkyl group, a branched or unbranched C₂-C₃₀ alkenyl group, a C₆-C₃₀ aryl group, or a C₇-C₃₀ aralkyl group; and m is an integer of 1 to 30;
b is 2 or 3;
c is 1 or 2, with the proviso that c is less than or equal to d; and
d is 1, 2, or 3.

19. The method of claim 18, wherein
(a) when L is —CH₂CH₂CH₂—, the polymer of Formula (II) is 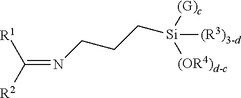
and is prepared by reacting the polymer fragment G with the silane compound of Formula (I) which is 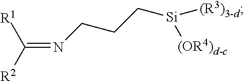
or
(b) when R¹ is —CH₂CH(CH₃)₂ and R² is —CH₃, the polymer of Formula (II) is 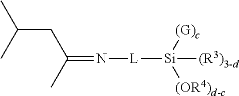
and is prepared by reacting the polymer fragment G with the silane compound of Formula (I) which is

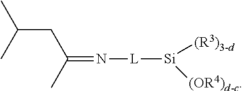

20. A method of making the polymer of claim 15, wherein the polymer is represented by Formula (VII) 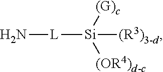
comprising reacting a polymer of Formula (II) 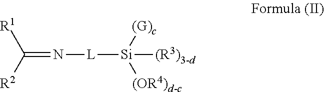
with water,
wherein
each R¹ and R² independently is hydrogen; an optionally substituted alkyl group having from 1 to 20 carbon atoms, where the optional substituent is one or more heteroatom; an optionally substituted alkenyl group having from 2 to 20 carbon atoms, where the optional substituents is one or more heteroatom; an optionally substituted cycloalkyl group having from 3 to 10 carbon atoms, where the optional substituent is one or more heteroatom; an optionally substituted aryl group having from 6 to 12 carbon atoms, where the optional substituent is one or more heteroatom; or an optionally substituted aralkyl group having from 7 to 16 carbon atoms, where the optional substituent is one or more heteroatom;
L is an optionally substituted alkylene group having from 1 to 20 carbon atoms, where the optional substituent is one or more heteroatom; an optionally substituted alkenylene group having from 2 to 20 carbon atoms, where the optional substituent is one or more heteroatom; an optionally substituted cycloalkylene group having from 3 to 10 carbon atoms, where the optional substituent is one or more heteroatom; an optionally substituted arylene group having from 6 to 12 carbon atoms, where the optional substituent is one or more heteroatom; or an optionally substituted aralkylene group having from 7 to 16 carbon atoms, where the optional substituent is one or more heteroatom;
R³ is an optionally substituted alkyl group having from 1 to 20 carbon atoms, where the optional substituent is one or more heteroatom; an optionally substituted alkenyl group having from 2 to 20 carbon atoms, where the optional substituent is one or more heteroatom; an optionally substituted cycloalkyl group having from 3 to 10 carbon atoms, where the optional substituent is one or more heteroatom; an optionally substituted aryl group having from 6 to 12 carbon atoms, where the optional substituent is one or more heteroatom; or an optionally substituted aralkyl group having from 7 to 16 carbon atoms, where the optional substituent is one or more heteroatom;
each R⁴ independently is an optionally substituted alkyl group having from 6 to 30 carbon atoms, where the optional substituent is one or more heteroatom; an optionally substituted alkenyl group having from 6 to 30 carbon atoms, where the optional substituent is one or more heteroatom; an optionally substituted alkynyl group having from 6 to 30 carbon atoms, where the optional substituent is one or more heteroatom; an optionally substituted cycloalkyl group having from 3 to 10 carbon atoms, where the optional substituent is one or more heteroatom; an optionally substituted aryl group having from 6 to 12 carbon atoms, where the optional substituent is one or more heteroatom; an optionally substituted aralkyl group having from 7 to 20 carbon atoms, where the optional substituent is one or more heteroatom; or an optionally substituted cyclic silane; or
R⁴ is R²³, where each R²³ independently is an optionally substituted straight chain or branched chain alkyl group, having from 1 to 10 carbon atoms, where two R²³ combine with each other to form a ring together with the —O—Si—O— atoms to which they are bonded, and where the optional substituent is one or more heteroatom, and wherein the two R²³ can be the same or different; or
each R⁴ independently is a group represented by —(R⁵—O)ₘ—R⁶, where where each R⁵ is the same as or different from each other and each represents a branched or unbranched C₁-C₃₀ divalent hydrocarbon group; R⁶ represents a branched or unbranched C₁-C₃₀ alkyl group, a branched or unbranched C₂-C₃₀ alkenyl group, a C₆-C₃₀ aryl group, or a C₇-C₃₀ aralkyl group; and m is an integer of 1 to 30;
G is is a polymer fragment having a backbone of carbon atoms covalently bonded together by C—C single bond, C═C double bond, or a combination of C—C single bonds and C═C double bonds;
c is 1 or 2, with the proviso that c is less than or equal to d; and
d is 1, 2, or 3.

21. A rubber composition comprising the polymer of claim 11.

22. (canceled)

23. A tire comprising the rubber composition of claim 21, wherein at least a tread of a tire or a sidewall of a tire is formed with the rubber composition.
